(19) United States
(12) Patent Application Publication
(10) Pub. No.: US 2026/0099030 A1
(43) Pub. Date: Apr. 9, 2026

(54) LENS OPTICAL SYSTEM AND IMAGING APPARATUS

(71) Applicant: SONY SEMICONDUCTOR SOLUTIONS CORPORATION, Kanagawa (JP)

(72) Inventors: Shinpei OGINO, Tokyo (JP); Daichi MURAKAMI, Tokyo (JP); Fumihiko HANZAWA, Tokyo (JP); Haruki TAKEUCHI, Kanagawa (JP); Masashi NAKAMURA, Tokyo (JP); Katsuji KIMURA, Kanagawa (JP)

(73) Assignee: SONY SEMICONDUCTOR SOLUTIONS CORPORATION, Kanagawa (JP)

(21) Appl. No.: 19/114,087

(22) PCT Filed: Sep. 11, 2023
(86) PCT No.: PCT/JP2023/032953

§ 371 Date: Mar. 21, 2025

(30) Foreign Application Priority Data
Sep. 30, 2022 (JP) 2022-157593

(51) Int. Cl. G02B 9/08; G02B 1/00; G02B 3/04; G02B 9/34; G02B 13/04; H04N 23/54; H04N 23/55

(52) U.S. Cl. CPC G02B 9/08; G02B 1/002; G02B 3/04; G02B 9/34; G02B 13/04; H04N 23/54; H04N 23/55; G02B 2207/101

(57) ABSTRACT

The present technology relates to a lens optical system and an imaging apparatus capable of improving optical performance in a wide-angle lens optical system having a metasurface. The lens optical system includes, in order from an incident side of light, a metalens having positive refractive power and an optical lens having positive refractive power. A metasurface including a plurality of nanostructures is arranged in the metalens. An aperture stop is arranged on the incident side of the metasurface. At least one optical surface of the second lens has an aspherical shape. The present technology can be applied to, for example, a wide-angle lens optical system that condenses light from a subject on a solid-state imaging element.

### TECHNICAL FIELD

The present technology relates to a lens optical system and an imaging apparatus, and more particularly to a lens optical system and an imaging apparatus capable of improving optical performance in a wide-angle lens optical system having a metasurface.

### BACKGROUND ART

A wide-angle lens optical system is essential for high-performance imaging and sensing. However, the wide-angle lens optical system requires a plurality of optical lenses, leading to an increase in size and weight, complication of assembly work, and the like.

On the other hand, it has been proposed to reduce the size of a lens optical system using a metalens (see, for example, Patent Document 1). Note that the metalens is a lens using a metasurface that polarizes incident light or modulates a phase or amplitude according to a subwavelength structure. It has been proposed to downsize a lens optical system by configuring a lens optical system in which a refractive lens and a metalens are combined and correcting positive chromatic aberration generated in the refractive lens with a metalens having negative chromatic aberration (see, for example, Patent Document 2).

### CITATION LIST

### Patent Document

Patent Document 1: Japanese Translation of PCT International Application Publication No. 2019-516128
Patent Document 2: Japanese Patent Application Laid-Open No. 2021-71727

### SUMMARY OF THE INVENTION

### Problems to be Solved by the Invention

However, improvement of optical performance in a wide-angle lens optical system having a metasurface has not yet been achieved. Therefore, there is a demand for providing a method capable of realizing such ingenuity, but such a demand is not sufficiently met.

The present technology has been made in view of such a situation, and an object thereof is to improve optical performance in a wide-angle lens optical system having a metasurface.

### Solutions to Problems

A lens optical system according to a first aspect of the present technology is a lens optical system including, in order from an incident side of light: a first lens having positive refractive power; and a second lens having positive refractive power, in which a metasurface including a plurality of nanostructures is arranged in the first lens, an aperture stop is arranged on the incident side of the metasurface, and at least one optical surface of the second lens has an aspherical shape.

In the first aspect of the present technology, the first lens having positive refractive power and the second lens having positive refractive power are provided in order from the incident side of light, the metasurface including the plurality of nanostructures is arranged in the first lens, the aperture stop is arranged on the incident side of the metasurface, and at least one optical surface of the second lens has an aspherical shape.

An imaging apparatus according to a second aspect of the present technology is an imaging apparatus including: a lens optical system including, in order from an incident side of light: a first lens having positive refractive power; and a second lens having positive refractive power, in which a metasurface including a plurality of nanostructures is arranged in the first lens, an aperture stop is arranged on the incident side of the metasurface, and at least one optical surface of the second lens has an aspherical shape; a solid-state imaging element in which light receiving elements are arranged in a two-dimensional lattice pattern; and a glass substrate arranged between a light receiving surface of the solid-state imaging element and the lens optical system.

In the second aspect of the present technology, the lens optical system including, in order from the incident side of light: the first lens having positive refractive power; and the second lens having positive refractive power, in which the metasurface including the plurality of nanostructures is arranged in the first lens, the aperture stop is arranged on the incident side of the metasurface, and at least one optical surface of the second lens has an aspherical shape, the solid-state imaging element in which the light receiving elements are arranged in a two-dimensional lattice pattern, and the glass substrate arranged between a light receiving surface of the solid-state imaging element and the lens optical system are provided.

A lens optical system according to a third aspect of the present technology is a lens optical system including, in order from an incident side of light: a first lens having negative refractive power in a vicinity of an optical axis; a second lens having positive refractive power in a vicinity of the optical axis; and an optical element having positive refractive power in a vicinity of the optical axis, in which a first optical surface of the optical element is configured by a flat surface or a curved surface, and a metasurface including a plurality of nanostructures is arranged on a second optical surface of the optical element.

In the third aspect of the present technology, the first lens having negative refractive power in the vicinity of the optical axis; the second lens having positive refractive power in the vicinity of the optical axis; and the optical element having positive refractive power in the vicinity of the optical axis are provided in order from the incident side of light, the first optical surface of the optical element is configured by the flat surface or the curved surface, and the metasurface including the plurality of nanostructures is arranged on the second optical surface of the optical element.

An imaging apparatus according to a fourth aspect of the present technology is an imaging apparatus including: a lens optical system including, in order from an incident side of light: a first lens having negative refractive power in a vicinity of an optical axis; a second lens having positive refractive power in a vicinity of the optical axis; and an optical element having positive refractive power in a vicinity of the optical axis, in which a first optical surface of the optical element is configured by a flat surface or a curved surface, and a metasurface including a plurality of nanostructures is arranged on a second optical surface of the optical element; a solid-state imaging element in which light receiving elements are arranged in a two-dimensional lattice pattern; and a glass substrate arranged between a light receiving surface of the solid-state imaging element and the lens optical system.

In the fourth aspect of the present technology, the lens optical system including, in order from the incident side of light: the first lens having negative refractive power in the vicinity of the optical axis; the second lens having positive refractive power in the vicinity of the optical axis; and the optical element having positive refractive power in the vicinity of the optical axis, in which the first optical surface of the optical element is configured by the flat surface or the curved surface, and the metasurface including the plurality of nanostructures is arranged on the second optical surface of the optical element, the solid-state imaging element in which the light receiving elements are arranged in a two-dimensional lattice pattern, and the glass substrate arranged between the light receiving surface of the solid-state imaging element and the lens optical system are provided.

A lens optical system according to a fifth aspect of the present technology is a lens optical system including, in order from an incident side of light: a first lens; a second lens; an optical element having positive refractive power in a vicinity of an optical axis; and a third lens, in which a first optical surface of the optical element is configured by a flat surface or a curved surface, a metasurface including a plurality of nanostructures is arranged on a second optical surface of the optical element, the metasurface has positive refractive power, and in a case where the first optical surface is arranged on the incident side with respect to the second optical surface, the second lens has positive refractive power in a vicinity of the optical axis, and in a case where the second optical surface is arranged on the incident side with respect to the first optical surface, the third lens has positive refractive power.

In the fifth aspect of the present technology, the first lens, the second lens, the optical element having positive refractive power in a vicinity of an optical axis, and the third lens are provided in order from the incident side of light, the first optical surface of the optical element is configured by the flat surface or the curved surface, the metasurface including the plurality of nanostructures is arranged on the second optical surface of the optical element, the metasurface has positive refractive power, and in a case where the first optical surface is arranged on the incident side with respect to the second optical surface, the second lens has positive refractive power in the vicinity of the optical axis, and in a case where the second optical surface is arranged on the incident side with respect to the first optical surface, the third lens has positive refractive power.

An imaging apparatus according to a sixth aspect of the present technology is an imaging apparatus including: a lens optical system including, in order from an incident side of light: a first lens; a second lens; an optical element having positive refractive power in a vicinity of an optical axis; and a third lens, in which a first optical surface of the optical element is configured by a flat surface or a curved surface, a metasurface including a plurality of nanostructures is arranged on a second optical surface of the optical element, the metasurface has positive refractive power, and in a case where the first optical surface is arranged on the incident side with respect to the second optical surface, the second lens has positive refractive power in a vicinity of the optical axis, and in a case where the second optical surface is arranged on the incident side with respect to the first optical surface, the third lens has positive refractive power; a solid-state imaging element in which light receiving elements are arranged in a two-dimensional lattice pattern; and a glass substrate arranged between a light receiving surface of the solid-state imaging element and the lens optical system.

According to the sixth aspect of the present technology, the lens optical system including, in order from the incident side of light: the first lens; the second lens; the optical element having positive refractive power in the vicinity of the optical axis; and the third lens, in which the first optical surface of the optical element is configured by the flat surface or the curved surface, the metasurface including the plurality of nanostructures is arranged on the second optical surface of the optical element, the metasurface has positive refractive power, and in a case where the first optical surface is arranged on the incident side with respect to the second optical surface, the second lens has positive refractive power in the vicinity of the optical axis, and in a case where the second optical surface is arranged on the incident side with respect to the first optical surface, the third lens has positive refractive power, the solid-state imaging element in which light receiving elements are arranged in a two-dimensional lattice pattern, and the glass substrate arranged between a light receiving surface of the solid-state imaging element and the lens optical system are provided.

### BRIEF DESCRIPTION OF DRAWINGS

FIG. 1 is a cross-sectional diagram showing a configuration example of a first embodiment of an imaging apparatus to which the present technology is applied.

FIG. 2 is a diagram showing an effect obtained by including a lens optical system in a CSP structure.

FIG. 3 is another diagram showing an effect obtained by including the lens optical system in the CSP structure.

FIG. 4 is a side view showing a configuration example of the lens optical system in FIG. 1.

FIG. 5 is a plan view of a metasurface.

FIG. 6 is a perspective view of a partial region of the metasurface.

FIG. 7 is a cross-sectional view of a partial region of the metasurface.

FIG. 8 is a diagram showing a first specification example of the lens optical system in FIG. 4.

FIG. 9 is a diagram showing a curvature radius, a surface interval, a refractive index, an Abbe number, and an effective diameter of each optical surface designed on the basis of the specifications of FIG. 8.

FIG. 10 is a diagram showing a conic constant and a coefficient of each optical surface designed on the basis of the specifications of FIG. 8.

FIG. 11 is a diagram showing a normalized wavelength, a diffraction order, and coefficients of the metasurface designed on the basis of the specifications of FIG. 8.

FIG. 12 is a diagram showing a profile of the metasurface designed on the basis of the specifications of FIG. 8.

FIG. 13 is a diagram showing examples of spherical aberration, field curvature, and distortion aberration generated in the lens optical system having the features of FIGS. 9 to 12.

FIG. 14 is a diagram showing a second specification example of the lens optical system in FIG. 4.

FIG. 15 is a diagram showing a curvature radius, a surface interval, a refractive index, an Abbe number, and an effective diameter of each optical surface designed on the basis of the specifications of FIG. 14.

FIG. 16 is a diagram showing a conic constant and a coefficient of each optical surface designed on the basis of the specifications of FIG. 14.

FIG. 17 is a diagram showing a normalized wavelength, a diffraction order, and coefficients of the metasurface designed on the basis of the specifications of FIG. 14.

FIG. 18 is a diagram showing a profile of the metasurface designed on the basis of the specifications of FIG. 14.

FIG. 19 is a diagram showing examples of spherical aberration, field curvature, and distortion aberration generated in the lens optical system having the features of FIGS. 15 to 18.

FIG. 20 is a diagram showing a third specification example of the lens optical system in FIG. 4.

FIG. 21 is a diagram showing a curvature radius, a surface interval, a refractive index, an Abbe number, and an effective diameter of each optical surface designed on the basis of the specifications of FIG. 20.

FIG. 22 is a diagram showing a conic constant and a coefficient of each optical surface designed on the basis of the specifications of FIG. 20.

FIG. 23 is a diagram showing a normalized wavelength, a diffraction order, and coefficients of the metasurface designed on the basis of the specifications of FIG. 20.

FIG. 24 is a diagram showing a profile of the metasurface designed on the basis of the specifications of FIG. 20.

FIG. 25 is a diagram showing examples of spherical aberration, field curvature, and distortion aberration generated in the lens optical system having the features of FIGS. 21 to 24.

FIG. 26 is a cross-sectional diagram showing another structural example of the metasurface.

FIG. 27 is a side view showing a configuration example of a lens optical system in a second embodiment of an imaging apparatus to which the present technology is applied.

FIG. 28 is a diagram showing a specification example of the lens optical system in FIG. 27.

FIG. 29 is a diagram showing a curvature radius, a surface interval, a refractive index, an Abbe number, and an effective diameter of each optical surface designed on the basis of the specifications of FIG. 28.

FIG. 30 is a diagram showing a conic constant and a coefficient of each optical surface designed on the basis of the specifications of FIG. 28.

FIG. 31 is a diagram showing a normalized wavelength, a diffraction order, and coefficients of the metasurface designed on the basis of the specifications of FIG. 28.

FIG. 32 is a diagram showing a profile of the metasurface designed on the basis of the specifications of FIG. 28.

FIG. 33 is a diagram showing examples of spherical aberration, field curvature, and distortion aberration generated in the lens optical system having the features of FIGS. 29 to 32.

FIG. 34 is a side view showing a configuration example of a lens optical system in a third embodiment of an imaging apparatus to which the present technology is applied.

FIG. 35 is a diagram showing a specification example of the lens optical system in FIG. 34.

FIG. 36 is a diagram showing a curvature radius, a surface interval, a refractive index, an Abbe number, and an effective diameter of each optical surface designed on the basis of the specifications of FIG. 35.

FIG. 37 is a diagram showing a conic constant and a coefficient of each optical surface designed on the basis of the specifications of FIG. 35.

FIG. 38 is a diagram showing a normalized wavelength, a diffraction order, and coefficients of the metasurface designed on the basis of the specifications of FIG. 35.

FIG. 39 is a diagram showing a profile of the metasurface designed on the basis of the specifications of FIG. 35.

FIG. 40 is a diagram showing examples of spherical aberration, field curvature, and distortion aberration generated in the lens optical system having the features of FIGS. 36 to 39.

FIG. 41 is a side view showing a configuration example of a lens optical system in a fourth embodiment of an imaging apparatus to which the present technology is applied.

FIG. 42 is a diagram showing a specification example of the lens optical system in FIG. 41.

FIG. 43 is a diagram showing a curvature radius, a surface interval, a refractive index, an Abbe number, and an effective diameter of each optical surface designed on the basis of the specifications of FIG. 42.

FIG. 44 is a diagram showing a conic constant and a coefficient of each optical surface designed on the basis of the specifications of FIG. 42.

FIG. 45 is a diagram showing a normalized wavelength, a diffraction order, and coefficients of the metasurface designed on the basis of the specifications of FIG. 42.

FIG. 46 is a diagram showing a profile of the metasurface designed on the basis of the specifications of FIG. 42.

FIG. 47 is a diagram showing examples of spherical aberration, field curvature, and distortion aberration generated in the lens optical system having the features of FIGS. 43 to 46.

FIG. 48 is a side view showing a configuration example of a lens optical system in a fifth embodiment of an imaging apparatus to which the present technology is applied.

FIG. 49 is a diagram showing a specification example of the lens optical system in FIG. 48.

FIG. 50 is a diagram showing a curvature radius, a surface interval, a refractive index, an Abbe number, and an effective diameter of each optical surface designed on the basis of the specifications of FIG. 49.

FIG. 51 is a diagram showing a normalized wavelength, a diffraction order, and coefficients of each of the metasurfaces designed on the basis of the specifications of FIG. 49.

FIG. 52 is a diagram showing a profile of one metasurface designed on the basis of the specifications of FIG. 49.

FIG. 53 is a diagram showing a profile of the other metasurface designed on the basis of the specifications of FIG. 49.

FIG. 54 is a diagram showing examples of spherical aberration, field curvature, and distortion aberration generated in the lens optical system having the features of FIGS. 50 to 53.

FIG. 55 is a side view showing a configuration example of a lens optical system including only one metalens as a lens.

FIG. 56 is a diagram showing a specification example of the lens optical system in FIG. 55.

FIG. 57 is a diagram showing a curvature radius, a surface interval, a refractive index, an Abbe number, and an effective diameter of each optical surface designed on the basis of the specifications of FIG. 56.

FIG. 58 is a diagram showing a normalized wavelength, a diffraction order, and coefficients of each of the metasurfaces designed on the basis of the specifications of FIG. 56.

FIG. 59 is a diagram showing a profile of the metasurface designed on the basis of the specifications of FIG. 56.

FIG. 60 is a diagram showing examples of spherical aberration, field curvature, and distortion aberration generated in the lens optical system having the features of FIGS. 57 to 59.

FIG. 61 is a side view showing a configuration example of a lens optical system including only four optical lenses as lenses.

FIG. 62 is a diagram showing a specification example of the lens optical system in FIG. 61.

FIG. 63 is a diagram showing a curvature radius, a surface interval, a refractive index, an Abbe number, and an effective diameter of each optical surface designed on the basis of the specifications of FIG. 62.

FIG. 64 is a diagram showing a conic constant and a coefficient of each optical surface designed on the basis of the specifications of FIG. 62.

FIG. 65 is a diagram showing an example of spherical aberration, field curvature, and distortion aberration generated in the lens optical system having the features of FIGS. 63 to 64.

FIG. 66 is a block diagram showing a configuration example of an imaging apparatus as an electronic apparatus to which the present technology is applied.

FIG. 67 is a diagram showing a usage example of the imaging apparatus.

FIG. 68 is a diagram showing an example of a schematic configuration of an endoscopic surgery system.

FIG. 69 is a block diagram showing an example of a functional configuration of a camera head and a camera control unit (CCU).

FIG. 70 is a block diagram showing an example of a schematic configuration of a vehicle control system.

FIG. 71 is an explanatory diagram showing an example of installation positions of a vehicle exterior information detection unit and an imaging section.

### MODE FOR CARRYING OUT THE INVENTION

Hereinafter, modes for carrying out the present technology (hereinafter, referred to as embodiments) will be described. Note that the description will be given in the following order.
1. First Embodiment (Imaging Apparatus Including Metalens and One Optical Lens)
2. Second Embodiment (Imaging Apparatus Including Metalens and Two Optical Lenses)
3. Third Embodiment (Imaging Apparatus Including Meta-Lens in which Metasurface is Arranged on Emission Side of Light and Three Optical Lenses)
4. Fourth Embodiment (Imaging Apparatus Including Meta-Lens in which Metasurface is Arranged on Incident Side of Light and Three Optical Lenses)
5. Fifth Embodiment (Imaging Apparatus Including Optical Element Having Two Metasurfaces)
6. Imaging Apparatus Including Only One Metalens as Lens
7. Imaging Apparatus Including Only Four Optical Lenses as Lenses>
8. Application Example to Electronic Apparatus
9. Usage Example of Imaging Apparatus
10. Application Example to Endoscopic Surgery System
11. Application Example to Mobile Body

Note that the same or similar portions are denoted by the same or similar reference signs in the drawings referred to in the following description. However, the drawings are schematic, and the relationship between the thickness and the plane dimension, the ratio of the thickness of each layer, and the like are different from the actual ones. Furthermore, the drawings may include portions having different dimensional relationships and ratios in some cases.

Furthermore, definition of directions such as upward and downward directions, and the like in the following description is merely the definition for ease of explanation, and does not limit the technical idea of the present disclosure. For example, when an object is rotated by 90° to be observed, the upper and lower sides are changed as the left and right sides, and, when the object is rotated by 180° to be observed, the upper and lower sides are reversed.

### First Embodiment

### <Configuration Example of Imaging Apparatus>

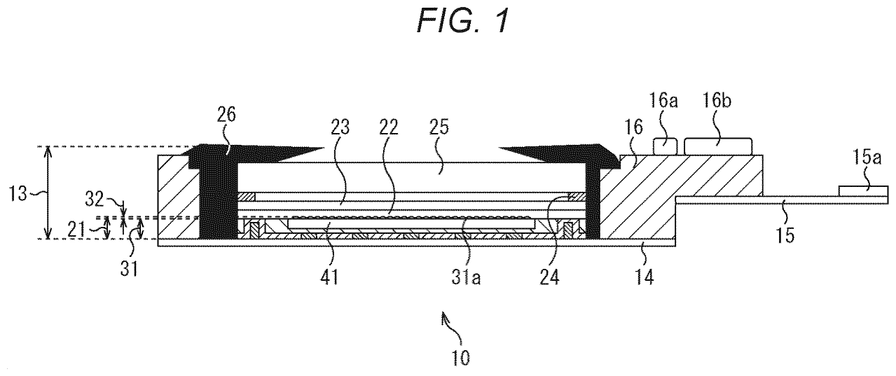

FIG. 1 is a cross-sectional diagram showing a configuration example of a first embodiment of an imaging apparatus to which the present technology is applied.

An imaging apparatus 10 in FIG. 1 includes a thin circuit board 14 on which a solid-state imaging apparatus 13 is installed, a circuit board 15, and a spacer 16.

The solid-state imaging apparatus 13 has a chip size package (CSP) structure. The CSP structure is one of the structures of the solid-state imaging apparatus that realizes a large number of pixels, a small size, and a low height, and is an extremely small package structure realized in the same size as the single chip. The solid-state imaging apparatus 13 includes a solid-state imaging element 21, an adhesive 22, a glass substrate 23, a black resin 24, a lens optical system 25, and a fixing agent 26.

The solid-state imaging element 21 is a charge-coupled device (CCD) sensor or a complementary metal oxide semiconductor (CMOS) image sensor, and includes a semiconductor substrate 31 and an on-chip lens 32. The lower surface of the semiconductor substrate 31 in FIG. 1 is connected to the circuit board 14. On a light receiving surface 31a that is a partial region of the upper surface of the semiconductor substrate 31 in FIG. 1, a pixel array 41 and the like including light receiving elements corresponding to a plurality of pixels arranged in a two-dimensional lattice pattern are formed. The on-chip lens 32 is formed at a position corresponding to each pixel on the pixel array 41.

The adhesive 22 is a transparent adhesive provided on the upper surface in FIG. 1 including the light receiving surface 31a of the solid-state imaging element 21. The glass substrate 23 is bonded to the solid-state imaging element 21 via the adhesive 22 for the purpose of fixing the solid-state imaging element 21, protecting the light receiving surface 31a, and the like.

The black resin 24 is formed on a surface of the glass substrate 23 opposite to the bonding surface of the adhesive 22, and has a function of a spacer. A bandpass filter (not shown) of the lens optical system 25 is installed on the glass substrate 23 via the black resin so as to be parallel to the glass substrate 23. As a result, the glass substrate 23 is arranged between the lens optical system 25 and the light receiving surface 31a. The black resin 24 (black mask) shields light outside the light receiving surface 31a among the light incident through the lens optical system 25.

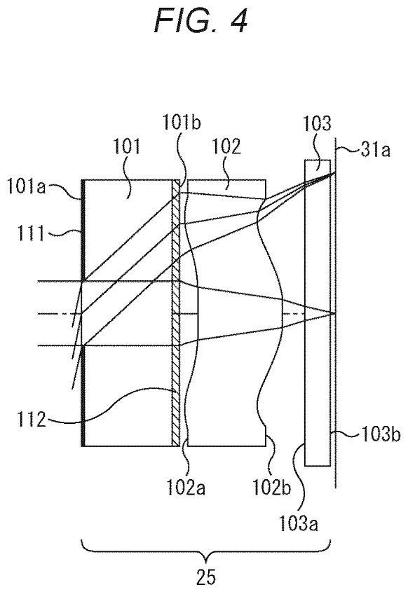

The lens optical system 25 is a wide-angle lens optical system. The configuration of the lens optical system 25 will be described in detail with reference to FIG. 4 described later.

The fixing agent 26 is applied to the side surfaces of the solid-state imaging element 21, the adhesive 22, the glass substrate 23, the black resin 24, and the lens optical system 25, and the periphery of the surface of the lens optical system 25 on the incident side of light (the upper surface in FIG. 1). The fixing agent 26 fixes the solid-state imaging element 21, the adhesive 22, the glass substrate 23, the black resin 24, and the lens optical system 25. The fixing agent 26 can reduce light that enters from the side surface of the solid-state imaging apparatus 13 and is refracted or reflected. Furthermore, the fixing agent 26 can shield light incident on the solid-state imaging apparatus 13 from the outside of the region corresponding to the light receiving surface 31a.

Light from the subject is condensed through the lens optical system 25, and is applied to the pixel array 41 through the glass substrate 23, the adhesive 22, and the on-chip lens 32. Each light receiving element of the pixel array 41 receives the light and generates an electric signal corresponding to the amount of received light to perform imaging.

As described above, since the lens optical system 25 is included in the CSP structure of the solid-state imaging apparatus 13, the imaging apparatus 10 can be downsized as compared with a case where the lens optical system 25 is provided separately.

The circuit board 14 is a circuit board that is connected to the lower surface of the semiconductor substrate 31 in FIG. 1 and outputs a camera signal corresponding to an electric signal generated by each light receiving element to the spacer 16.

The circuit board 15 is a circuit board for outputting a camera signal output from the circuit board 14 via the spacer 16 to the outside, and electronic components and the like are mounted on the circuit board 15. The circuit board 15 has a connector 15a for connection with an external device, and outputs a camera signal to the external device.

The spacer 16 is a circuit built-in spacer for fixing an actuator (not shown) that drives the lens optical system 25 and the circuit board 15. Semiconductor components 16a and 16b and the like are mounted on the spacer 16. The semiconductor components 16a and 16b are a capacitor, a semiconductor component constituting a large scale integration (LSI) that controls an actuator (not shown) that drives the lens optical system 25, and the like. The spacer 16 outputs the camera signal output from the circuit board 14 to the circuit board 15.

### <Description of Effect by Including Lens Optical System in CSP Structure>

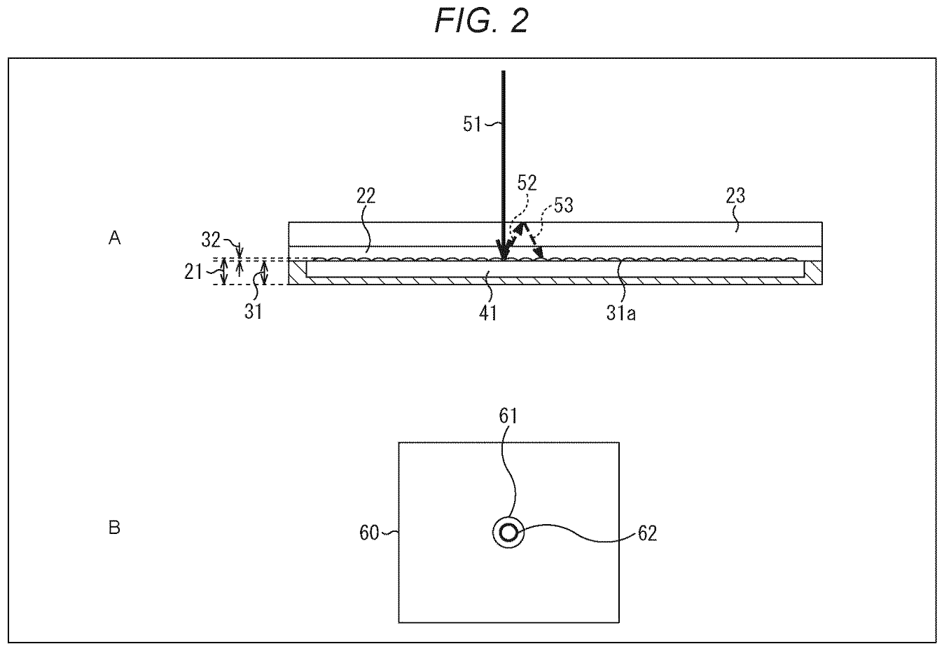

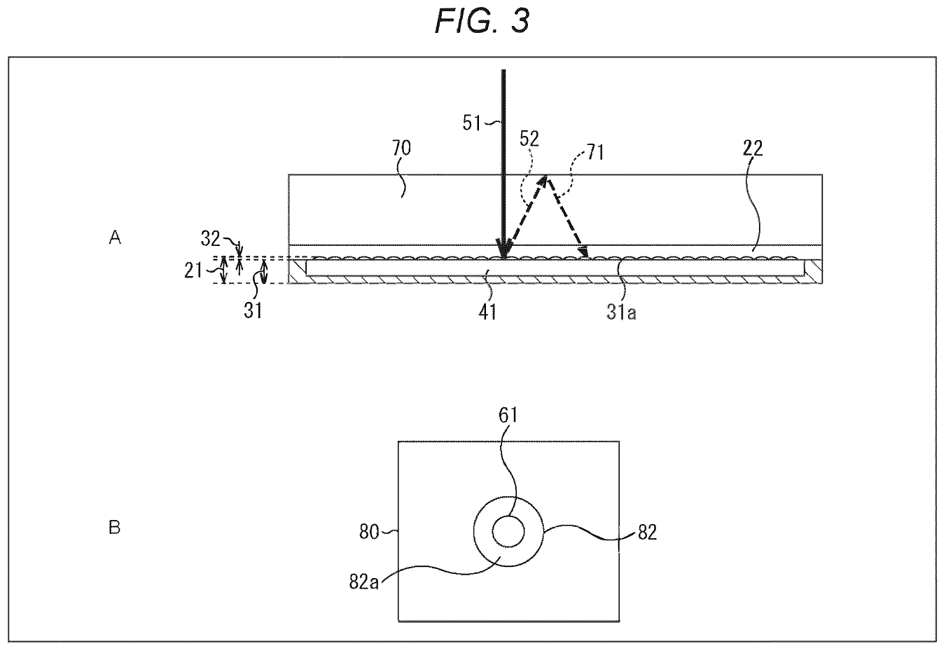

Next, effects obtained by including the lens optical system in the CSP structure of the solid-state imaging apparatus 13 will be described with reference to FIGS. 2 and 3.

A of FIG. 2 and A of FIG. 3 are cross-sectional views of a part of the solid-state imaging element 21, the adhesive 22, and the glass substrate 23, and B of FIG. 2 and B of FIG. 3 are views showing captured images.

In the imaging apparatus 10, the lens optical system 25 is fixed to the solid-state imaging element 21 or the like with the fixing agent 26, and is included in the solid-state imaging apparatus 13 having a CSP structure. Therefore, even if the thicknesses of the adhesive 22 and the glass substrate 23 arranged on the solid-state imaging element 21 are reduced, the strength of the entire solid-state imaging apparatus 13 can be secured. As a result, as shown in A of FIG. 2, the glass substrate 23 can be thinned.

In such an imaging apparatus 10, as shown in A of FIG. 2, when light 51 from a light source (not shown) is incident as light from a subject, an image of light 51 is projected on the light receiving surface 31a with a certain spread and received by the light receiving element of the pixel array 41. At this time, a part of the light 51, that is, light 52 is totally reflected by the light receiving surface 31a on which the on-chip lens 32 is formed. A part of the light 52 totally reflected by the on-chip lens 32, that is, light 53 is totally reflected by the boundary surface between the glass substrate 23 and the air layer (the surface of the glass substrate 23 on the incident side of light), folded back to the light receiving surface 31a, and received by the light receiving element of the pixel array 41.

The distance between the light receiving position of the light 51 directly incident from the light source and the light receiving position of the folded light 53 corresponds to the sum of the thicknesses of the adhesive 22 and the glass substrate 23, and the larger the sum of the thicknesses, the longer the distance. As described above, since the glass substrate 23 can be thinned in the imaging apparatus 10, the distance between the light receiving position of the light 51 and the light receiving position of the light 53 can be shortened, and for example, can be made smaller than the radius of the image of the light 51. As a result, as shown in B of FIG. 2, in a captured image 60, a circular region 62 corresponding to the image of the light 53 is included in a circular region 61 corresponding to the image of the light 51. As a result, occurrence of flare and ghost in the captured image 60 can be suppressed, and the image quality of the captured image 60 can be improved.

Note that the refractive index of the air layer between the glass substrate 23 and the lens optical system 25 is 1.0, and the refractive index of the glass substrate 23 is, for example, 1.5.

On the other hand, in a case where the lens optical system 25 is not included in the CSP structure of the solid-state imaging apparatus, in order to secure the strength of the entire solid-state imaging apparatus, for example, as shown in A of FIG. 3, it is necessary to provide a thick glass substrate 70 on the solid-state imaging element 21. The refractive index of the glass substrate 70 is, for example, 1.5 similarly to the glass substrate 23.

In this case, in the light 52 totally reflected by the light receiving surface 31a, a distance between a light receiving position of the light 71 totally reflected by the boundary surface between the glass substrate 70 and the air layer and folded back to the light receiving surface 31a and a light receiving position of the light 51 directly incident from the light source becomes long. Therefore, the distance is larger than the radius of the image of the light 51. As a result, as shown in B of FIG. 3, in a captured image 80, a circular region 82 corresponding to the image of the light 71 is larger than the circular region 61 corresponding to the image of the light 51. Therefore, flare or ghost occurs with respect to the subject image due to a region 82a outside the region 61 in the region 82, and the image quality of the captured image 80 is deteriorated.

When the thickness of the glass substrate 70 is reduced in order to suppress degradation of the image quality of the captured image 80, the strength of the entire solid-state imaging apparatus decreases, and it is difficult to obtain a good result in a reliability test such as a drop test.

As described above, since the imaging apparatus 10 includes the lens optical system 25 in the CSP structure of the solid-state imaging apparatus 13, it is possible to suppress deterioration in image quality of a captured image while securing durability of the entire solid-state imaging apparatus 13. In addition, the imaging apparatus 10 can be downsized by thinning the glass substrate 23.

### <Configuration Example of Lens Optical System>

FIG. 4 is a side view showing a configuration example of the lens optical system 25.

As shown in FIG. 4, the lens optical system 25 includes, in order from an incident side of light (left side in FIG. 4), a metalens 101 (first lens), an optical lens 102 (second lens), and a band pass filter 103.

The metalens 101 is an optical element having positive refractive power in the vicinity of the optical axis. An aperture stop 111 is arranged on an optical surface 101a of the metalens 101 on the incident side of light (image enlargement side). A metasurface 112 including a plurality of nanostructures is arranged on the optical surface 101b on the emission side of light (image reduction side) of the metalens 101. That is, the aperture stop 111 is arranged on the incident side of the metasurface 112. Note that, in the example of FIG. 4, the aperture stop 111 is arranged on the optical surface 101a, but may be separated from the metalens 101 as long as the aperture stop 111 is arranged on the incident side of the metasurface 112.

The optical lens 102 has positive refractive power in the vicinity of the optical axis. An optical surface 102a on the incident side of light and an optical surface 102b on the light emitting side of the optical lens 102 have an aspherical shape having an inflection point. Note that, here, it is assumed that both the shapes of the optical surfaces 102a and 102b are aspherical shapes having an inflection point, but at least one of the shapes may be an aspherical shape having an inflection point.

The band pass filter 103 transmits only light of a predetermined frequency among the light incident from the optical surface 103a on the incident side of light and emits the light from the optical surface 103b on the emission side of light. Examples of the band pass filter 103 include an infrared cut filter (IRCF) and the like.

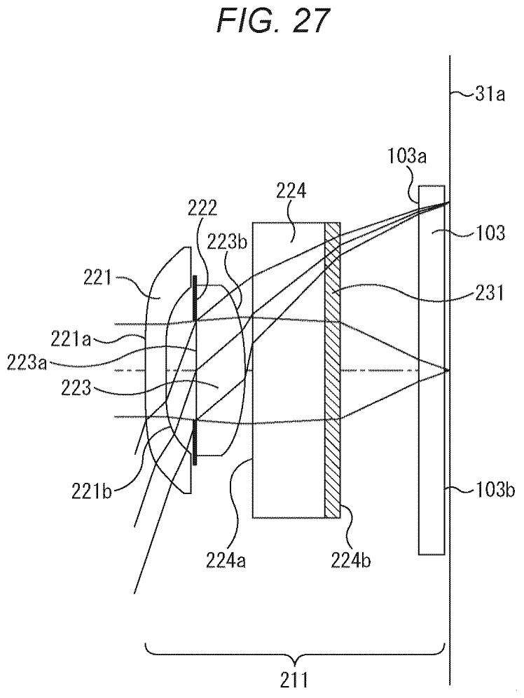

Light from the subject is incident on the optical surface 101a of the metalens 101, and is emitted through the optical surface 101b, the optical surface 102a, the optical surface 102b, the optical surface 103a, and the optical surface 103b. The light emitted from the lens optical system 25 in this manner is condensed on the light receiving surface 31a via the glass substrate 23, the adhesive 22, and the on-chip lens 32. In FIG. 4, only the light receiving surface 31a is shown in order to simplify the drawing, but actually, the glass substrate 23, the adhesive 22, and the on-chip lens 32 exist between the lens optical system 25 and the light receiving surface 31a. This similarly applies to FIGS. 27, 34, 41, 48, 55, and 61 described later.

As described above, the lens optical system 25 realizes a wide-angle lens optical system by the metalens 101 and the optical lens 102. Therefore, the size can be reduced as compared with a case where the wide-angle lens optical system is realized only by the optical lens.

Since the metalens 101 has the aperture stop 111 on the optical surface 101a on the incident side of light, it is possible to separate the on-axis light flux and the off-axis light flux incident on the metasurface 112 as shown in FIG. 4. As a result, in the optical lens 102, it is possible to easily correct aberrations such as coma aberration, field curvature, astigmatism aberration, spherical aberration, and distortion aberration depending on the angle of the incident angle of the off-axis light flux. Furthermore, the incident angle of the off-axis light flux with respect to the metasurface 112 is smaller (shallower) than a case where the off-axis light flux is directly incident on the metasurface 112 from the air. Therefore, the phase delay amount in the metasurface 112 can be reduced. As a result, a decrease in efficiency in the metasurface 112 can be suppressed, and the optical performance of the lens optical system 25 can be improved. As described in David Sell, Jianji Yang, Sage Doshay, Rui Yang, Jonathan A. Fan, “Large-Angle, Multifunctional Metagratings Based on Freeform Multimode Geometries” Nano Letters, vol. 17, issue 6, pp. 3752-3757 June 2017, and the like, metasurface generally decreases in efficiency with an increase in diffraction angle.

Since the metalens 101 and the optical lens 102 have positive refractive power in the vicinity of the optical axis, it is possible to realize the lens optical system 25 that is thin and has a small F value (bright) as compared with a case where either one has negative refractive power.

Since the optical lens 102 has the optical surfaces 102a and 102b having an aspherical shape, the aberration generated in the metasurface 112 can be corrected by the optical surfaces 102a and 102b. Therefore, the lens optical system 25 can be compact, reduce aberration, and improve optical performance. This aberration correction function is further improved by the aspherical shape having an inflection point. In the metalens 101, since the metasurface 112 is arranged on the optical surface 101b on the emission side of light, it is possible to suppress a change in performance in a case where the thickness of the metalens 101 changes due to variations or the like at the time of manufacture.

### <Structural Example of Meta-Surface>

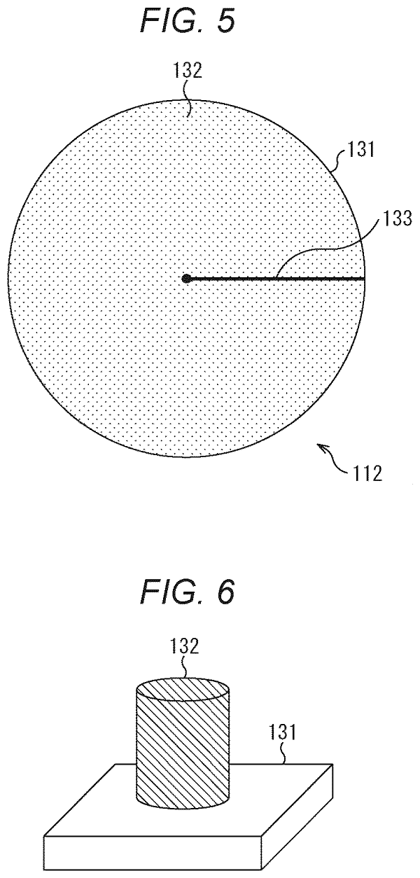

Next, a structural example of the metasurface 112 will be described with reference to FIGS. 5 to 7.

FIG. 5 is a plan view of the metasurface 112.

As shown in FIG. 5, the metasurface 112 is configured by forming a plurality of nanostructures 132 on a substrate 131. The planar shape of the substrate 131 is, for example, a circular shape having a radius 133. The substrate 131 and the nanostructures 132 are desirably dielectrics including TiO2, SiO2, α-Si, SiN, TIN, SION, TiON, or the like.

FIG. 6 is a perspective view of a region of the metasurface 112 where one nanostructure 132 is arranged.

As shown in FIG. 6, the shape of the nanostructure 132 is, for example, a cylindrical shape. The nanostructure 132 is a nano-order structure, and polarizes incident light or modulates a phase or amplitude. Therefore, the wavefront of the light transmitted through the metasurface 112 is different from the wavefront of the light incident on the metasurface 112.

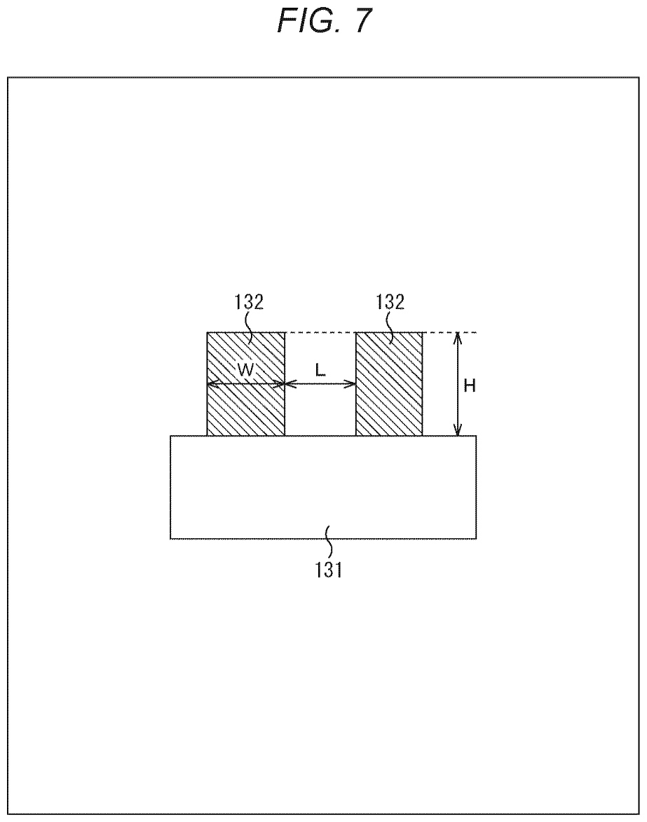

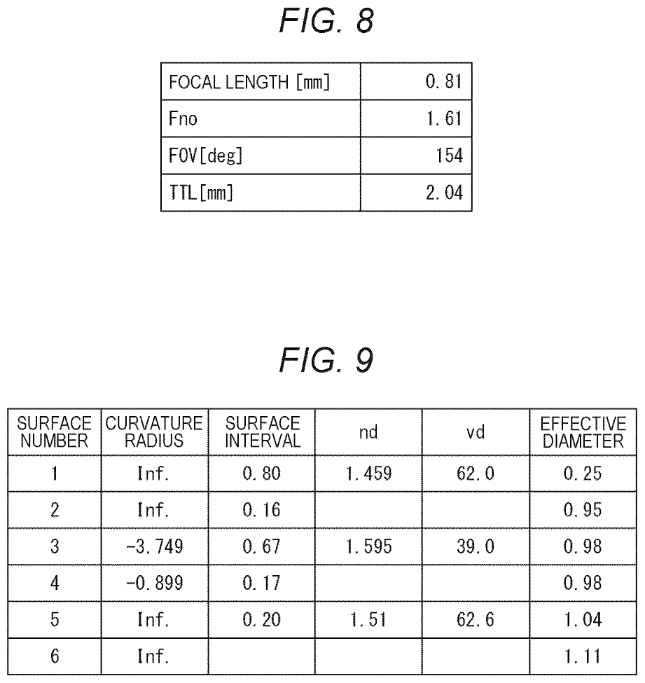

FIG. 7 is a cross-sectional view of a region where two nanostructures 132 are arranged in the metasurface 112.

Here, since the shape of the nanostructure 132 is a cylindrical shape, the cross-sectional shape of the nanostructure 132 is rectangular as shown in FIG. 7. Note that the shape of the nanostructure 132 is not limited to a cylindrical shape, and the cross-sectional shape may be a shape including a polygonal shape such as a square shape or a rectangular shape, or a curved shape such as a circular shape or an elliptical shape. The nanostructures 132 may be hollow.

The phase delay amount in the metasurface 112 can be controlled by adjusting the height H and the width W of the nanostructure 132, the distance L between two adjacent nanostructures 132, and the like. The width W and the distance L are set within a range of 50 to 750 nm, for example, and the height H is set within a range of 50 to 1000 nm, for example.

### <First Specification Example of Lens Optical System>

FIG. 8 is a diagram showing a first specification example of the lens optical system 25.

In the specifications of FIG. 8, the focal length is 0.81 mm, the F-number (Fno) is 1.61, the field of view (FOV) is 154 degrees, and the total length TTL of the lens optical system 25 is 2.04. Therefore, 1/(Fno×TTL) is about 0.305.

### <First Characteristic Example of Each Optical Surface>

Next, examples of features of each optical surface of the lens optical system 25 designed on the basis of the specifications of FIG. 8 will be described with reference to FIGS. 9 to 12.

In FIGS. 9 to 11, surface numbers 1 to 6 are sequentially assigned to the optical surfaces 101a, 101b, 102a, 102b, 103a, and 103b. This similarly applies to FIGS. 15 to 17 and FIGS. 21 to 23 described later.

The table of FIG. 9 shows, in association with each surface number, the curvature radius, the surface interval, the refractive index nd with respect to the d line (wavelength 588 nm), the Abbe number vd with respect to the d line, and the effective diameter of the optical surfaces 101a, 101b, 102a, 102b, 103a, or 103b corresponding to the surface number.

As shown in FIG. 9, the curvature radius of the optical surface 101a with the surface number “1” is infinite (Inf), the surface interval with the optical surface 101b is 0.80 mm, the refractive index nd is 1.459, vd is 62.0, and the effective diameter is 0.25 mm. Therefore, the interval between the aperture stop 111 arranged on the optical surface 101a and the metasurface 112 arranged on the optical surface 101b is 0.80 mm. The curvature radius of the optical surface 101b with the surface number “2” is infinite, the surface interval with the optical surface 102a is 0.16 mm, and the effective diameter is 0.95 mm.

The curvature radius of the optical surface 102a with the surface number “3” is −3.749, the surface interval with the optical surface 102b is 0.67 mm, the refractive index nd is 1.595, vd is 39.0, and the effective diameter is 0.98 mm. The curvature radius of the optical surface 102b with the surface number “4” is −0.899, the surface interval with the optical surface 103a is 0.17 mm, and the effective diameter is 0.98 mm.

The curvature radius of the optical surface 103a with the surface number “5” is infinite, the surface interval with the optical surface 103b is 0.20 mm, the refractive index nd is 1.51, vd is 62.6, and the effective diameter is 1.04 mm. The curvature radius of the optical surface 103b with the surface number “6” is infinite, and the effective diameter is 1.11 mm.

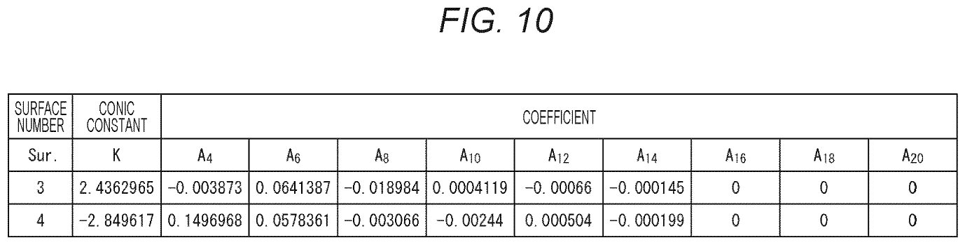

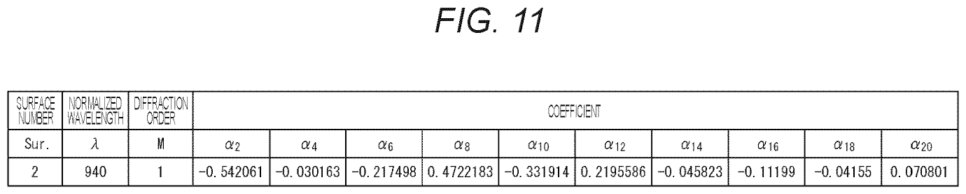

The table of FIG. 10 shows a conic constant and a coefficient in a function of a sag amount as a profile of an aspherical shape of the optical surface 102a or 102b corresponding to the surface number of the optical surfaces 102a and 102b in association with each surface number.

Here, the sag amount is represented by Formula (1) below.

$$[ Math . 1 ]$$

$$Z ( r ) = \frac{{Cr}^{2}}{1 + \sqrt{1 - ( 1 + K ) {C}^{2} {r}^{2}}} + {\sum }_{i = 2}^{n} {A}_{2 i} {r}^{2 i} \qquad ( 1 )$$

In Formula (1), Z is a sag amount in a direction parallel to the optical axis of the lens optical system 25, r is a distance from the optical axis, and C is a curvature, that is, a reciprocal of a curvature radius. K is a conic constant and A₂ᵢ is a coefficient.

As shown in FIG. 10, the conic constant K of the optical surface 102a with the surface number “3” is 2.4362965. The coefficients A₄, A₆, A₈, A₁₀, A₁₂, and A₁₄ are −0.003873, 0.0641387, −0.018984, 0.0004119, −0.00066, and −0.000145, respectively. The coefficients A₁₆, A₁₈, and A₂₀ are all 0.

The conic constant K of the optical surface 102b with the surface number “4” is −2.849617. The coefficients A₄, A₆, A₈, A₁₀, A₁₂, and A₁₄ are 0.1496968, 0.0578361, −0.003066, −0.00244, 0.000504, and −0.000199, respectively. The coefficients A₁₆, A₁₈, and A₂₀ are all 0.

The table of FIG. 11 shows the normalized wavelength, the diffraction order, and the coefficient in the function of the phase delay amount as the phase profile of the metasurface 112 arranged on the optical surface 101b in association with the surface number of the optical surface 101b.

Here, the phase delay amount (phase shift) is represented by Formula (2) below.

$$[ Math . 2 ]$$

$$ψ ( r ) = \frac{M}{λ} {\sum }_{i = 1}^{n} {α}_{2 i} {r}^{2 i} \qquad ( 2 )$$

In Formula (2), w is a phase delay amount, r is a distance from the optical axis, λ is a normalized wavelength, M is a diffraction order, and α₂ᵢ is a coefficient. The function of Formula (2) represents the phase delay amount at each position on the radius 133 of the metasurface 112 of FIG. 5 described above.

As shown in FIG. 11, the normalized wavelength A of the metasurface 112 arranged on the optical surface 101b with the surface number “2” is 940, and the diffraction order M is 1. The coefficients α₂, α₄, α₆, α₈, α₁₀, α₁₂, α₁₄, α₁₆, α₁₈, and α₂₀ are −0.542061, −0.030163, −0.217498, 0.4722183, −0.331914, 0.2195586, −0.045823, −0.11199, −0.04155, and 0.070801, respectively.

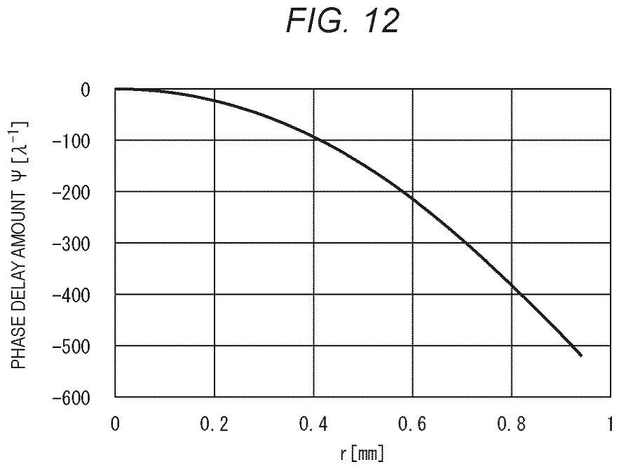

The graph of FIG. 12 shows a profile of the metasurface 112.

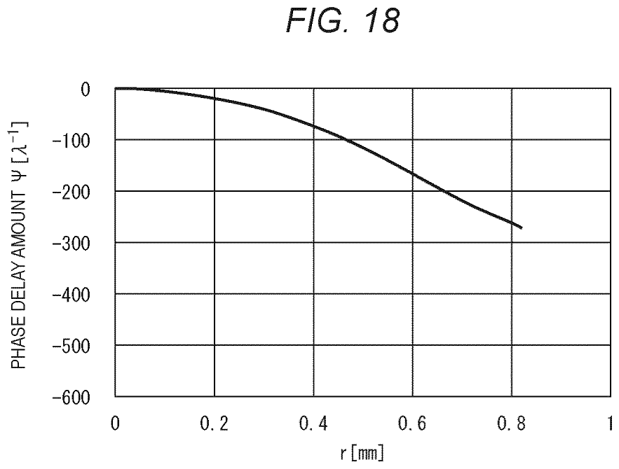

In FIG. 12, the horizontal axis represents the distance r [mm] from the optical axis, and the vertical axis represents the phase delay amount ψ [λ⁻¹]. This similarly applies to FIGS. 18, 24, 32, 39, 46, 52, 53, and 59 described later.

As shown in FIG. 12, when the distance r from the optical axis is in a range from 0 mm to around 0.9 mm, the phase delay amount ψ changes from 0 to around −500 such that the phase delay amount ψ increases in the negative direction as the distance r increases.

### <First Example of Spherical Aberration, Field Curvature, and Distortion Aberration>

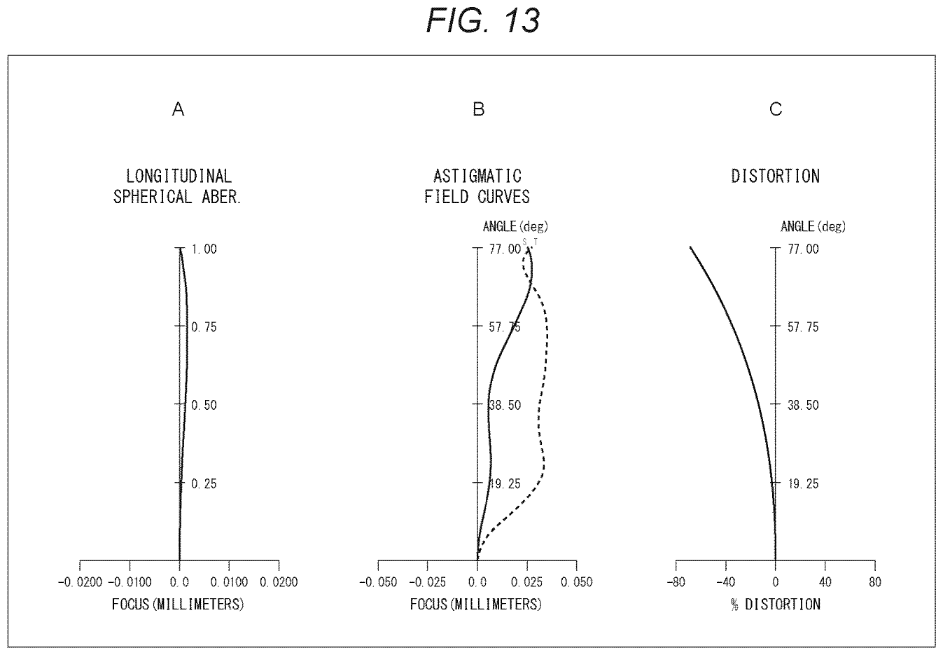

FIG. 13 is a diagram showing an example of spherical aberration, field curvature, and distortion aberration generated in the lens optical system 25 having the features of FIGS. 9 to 12.

A of FIG. 13 is a graph showing longitudinal spherical aberration generated in the lens optical system 25 having the features of FIGS. 9 to 12. In the graph in A of FIG. 13, the horizontal axis represents the shift amount (Focus) [mm] of the condensing position, and the vertical axis represents the incident position (height) of the light beam.

B of FIG. 13 is a graph showing field curvature (field curves) generated in the lens optical system 25 having the features of FIGS. 9 to 12. In the graph in B of FIG. 13, the horizontal axis represents the shift amount (Focus) [mm] of the condensing position, and the vertical axis represents the angle [degree] corresponding to the incident position in the sagittal direction or the tangential direction of the light beam. A solid line represents the relationship between the incident position in the sagittal direction and the shift amount of the condensing position, and a dotted line represents the relationship between the incident position in the tangential direction and the shift amount of the condensing position. The difference in the shift amount between the condensing positions in the sagittal direction and the tangential direction is astigmatic.

C of FIG. 13 is a graph showing distortion aberration generated in the lens optical system 25 having the features of FIGS. 9 to 12. In the graph in C of FIG. 13, the horizontal axis represents distortion aberration [%], and the vertical axis represents the incident angle [degree] of the light beam.

### <Second Specification Example of Lens Optical System>

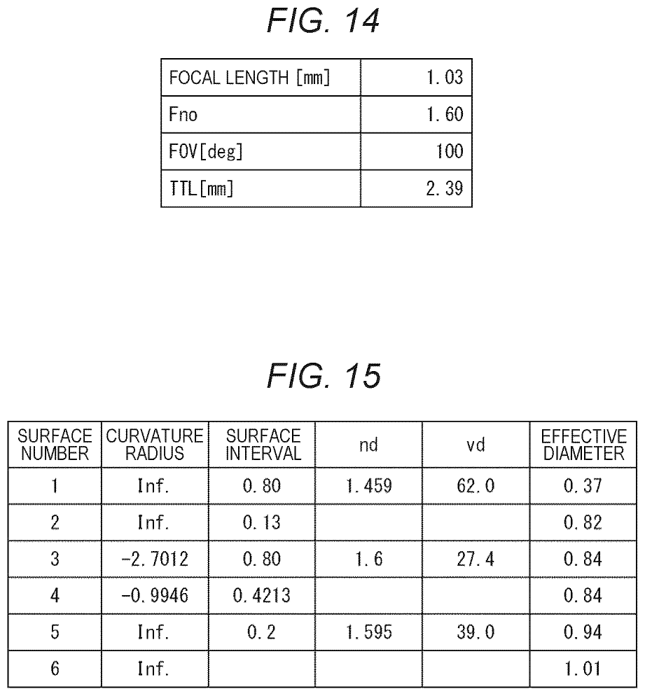

FIG. 14 is a diagram showing a second specification example of the lens optical system 25.

In the specifications of FIG. 14, the focal length is 1.03 mm, the F-number is 1.60, the FOV is 100 degrees, and the total length TTL of the lens optical system 25 is 2.39. Therefore, 1/(Fno×TTL) is about 0.261.

### <Second Characteristic Example of Each Optical Surface>

Next, examples of features of each optical surface of the lens optical system 25 designed on the basis of the specifications of FIG. 14 will be described with reference to FIGS. 15 to 18.

The table of FIG. 15 shows the curvature radius, the surface interval, the refractive index nd, the Abbe number vd, and the effective diameter of the optical surfaces 101a, 101b, 102a, 102b, 103a, or 103b corresponding to the surface numbers in association with the surface numbers.

As shown in FIG. 15, the curvature radius of the optical surface 101a with the surface number “1” is infinite, the surface interval with the optical surface 101b is 0.80 mm, the refractive index nd is 1.459, vd is 62.0, and the effective diameter is 0.37 mm. Therefore, the interval between the aperture stop 111 arranged on the optical surface 101a and the metasurface 112 arranged on the optical surface 101b is 0.80 mm. The curvature radius of the optical surface 101b with the surface number “2” is infinite, the surface interval with the optical surface 102a is 0.13 mm, and the effective diameter is 0.82 mm.

The curvature radius of the optical surface 102a with the surface number “3” is −2.7012, the surface interval with the optical surface 102b is 0.80 mm, the refractive index nd is 1.6, vd is 27.4, and the effective diameter is 0.84 mm. The curvature radius of the optical surface 102b with the surface number “4” is −0.9946, the surface interval with the optical surface 103a is 0.4213 mm, and the effective diameter is 0.84 mm.

The curvature radius of the optical surface 103a with the surface number “5” is infinite, the surface interval with the optical surface 103b is 0.20 mm, the refractive index nd is 1.595, vd is 39.0, and the effective diameter is 0.94 mm. The curvature radius of the optical surface 103b with the surface number “6” is infinite, and the effective diameter is 1.01 mm.

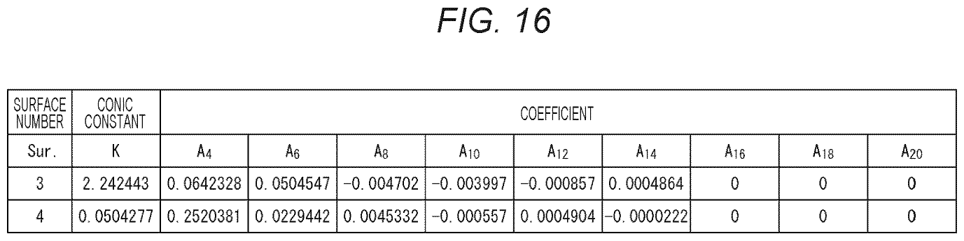

The table of FIG. 16 shows the conic constant K and the coefficient A₂ᵢ in Formula (1) described above as the profile of the aspherical shape of the optical surface 102a or 102b corresponding to each surface number of the optical surfaces 102a and 102b in association with each surface number.

As shown in FIG. 16, the conic constant K of the optical surface 102a with the surface number “3” is 2.242443. The coefficients A₄, A₆, A₈, A₁₀, A₁₂, and A₁₄ are 0.0642328, 0.0504547, −0.004702, −0.0039997, −0.000857, and 0.0004864, respectively. The coefficients A₁₆, A₁₈, and A₂₀ are all 0.

The conic constant K of the optical surface 102b with the surface number “4” is 0.0504277. The coefficients A₄, A₆, As, A₁₀, A₁₂, and A₁₄ are 0.2520381, 0.0229442, 0.0045332, −0.000557, 0.0004902, and −0.0000222, respectively. The coefficients A₁₆, A₁₈, and A₂₀ are all 0.

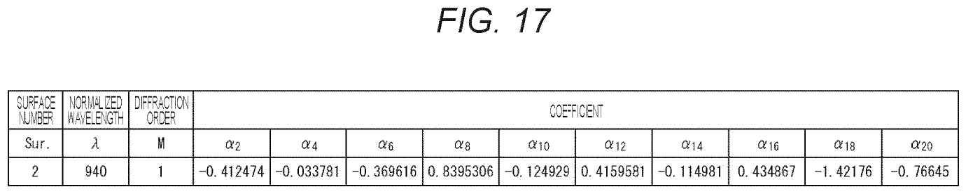

The table of FIG. 17 shows the normalized wavelength λ, the diffraction order M, and the coefficient α₂ᵢ in Formula (2) described above as the phase profile of the metasurface 112 arranged on the optical surface 101b in association with the surface number of the optical surface 101b.

As shown in FIG. 17, the normalized wavelength λ of the metasurface 112 arranged on the optical surface 101b with the surface number “2” is 940, and the diffraction order M is 1. The coefficients α₂, α₄, α₆, α₈, α₁₀, α₁₂, α₁₄, α₁₆, α₁₈, and α₂₀ are −0.412474, −0.033781, −0.369616, 0.8395306, −0.124929, 0.4159581, −0.114981, 0.434867, −1.42176, and −0.76645, respectively.

The graph of FIG. 18 shows a profile of the metasurface 112.

As shown in FIG. 18, when the distance r from the optical axis is in a range from 0 mm to around 0.8 mm, the phase delay amount ψ changes from 0 to around −300 such that the phase delay amount ψ increases in the negative direction as the distance r increases.

### <Second Example of Spherical Aberration, Field Curvature, and Distortion Aberration>

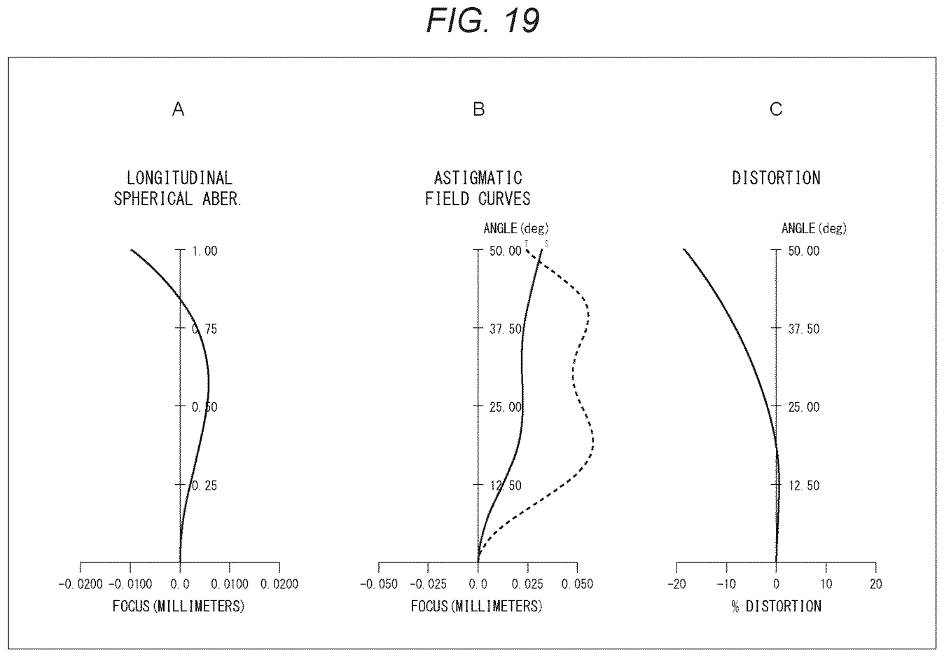

FIG. 19 is a diagram showing an example of spherical aberration, field curvature, and distortion aberration generated in the lens optical system 25 having the features of FIGS. 15 to 18.

A of FIG. 19 is a graph showing the spherical aberration in the longitudinal direction generated in the lens optical system 25 having the features of FIGS. 15 to 18, similarly to A of FIG. 13. B of FIG. 19 is a graph showing the field curvature generated in the lens optical system 25 having the features of FIGS. 15 to 18, similarly to B of FIG. 13. C of FIG. 19 is a graph showing distortion aberration generated in the lens optical system 25 having the features of FIGS. 15 to 18, similarly to C of FIG. 13.

### <Third Specification Example of Lens Optical System>

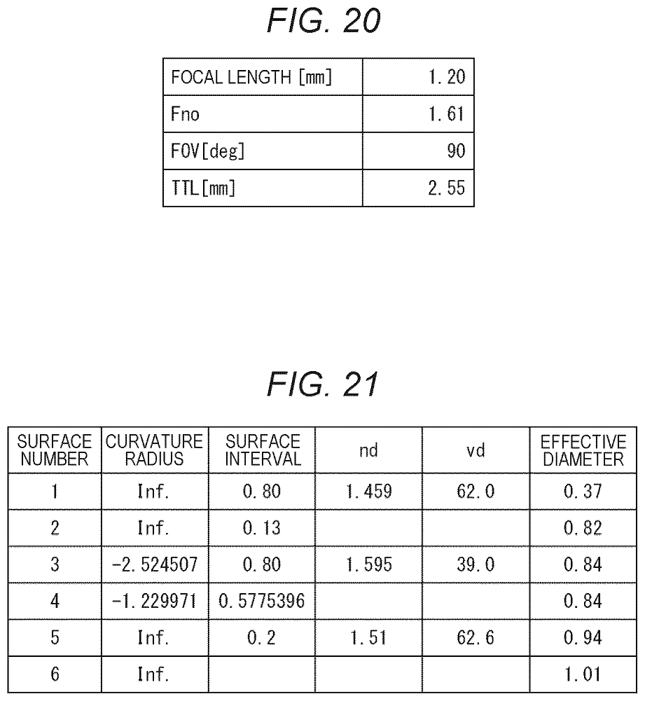

FIG. 20 is a diagram showing a third specification example of the lens optical system 25.

In the specifications of FIG. 20, the focal length is 1.20 mm, the F-number is 1.61, the FOV is 90 degrees, and the total length TTL of the lens optical system 25 is 2.55. Therefore, 1/(Fno×TTL) is about 0.243.

### <Third Characteristic Example of Each Optical Surface>

Next, examples of features of each optical surface of the lens optical system 25 designed on the basis of the specifications of FIG. 20 will be described with reference to FIGS. 21 to 24.

The table of FIG. 21 shows the curvature radius, the surface interval, the refractive index nd, the Abbe number vd, and the effective diameter of the optical surfaces 101a, 101b, 102a, 102b, 103a, or 103b corresponding to the surface numbers in association with the surface numbers.

As shown in FIG. 21, the curvature radius of the optical surface 101a with the surface number “1” is infinite, the surface interval with the optical surface 101b is 0.80 mm, the refractive index nd is 1.459, vd is 62.0, and the effective diameter is 0.37 mm. Therefore, the interval between the aperture stop 111 arranged on the optical surface 101a and the metasurface 112 arranged on the optical surface 101b is 0.80 mm. The curvature radius of the optical surface 101b with the surface number “2” is infinite, the surface interval with the optical surface 102a is 0.13 mm, and the effective diameter is 0.82 mm.

The curvature radius of the optical surface 102a with the surface number “3” is −2.524507, the surface interval with the optical surface 102b is 0.80 mm, the refractive index nd is 1.595, vd is 39.0, and the effective diameter is 0.84 mm. The curvature radius of the optical surface 102b with the surface number “4” is −1.229971, the surface interval with the optical surface 103a is 0.5775396 mm, and the effective diameter is 0.84 mm.

The curvature radius of the optical surface 103a with the surface number “5” is infinite, the surface interval with the optical surface 103b is 0.2 mm, the refractive index nd is 1.51, vd is 62.6, and the effective diameter is 0.94 mm. The curvature radius of the optical surface 103b with the surface number “6” is infinite, and the effective diameter is 1.01 mm.

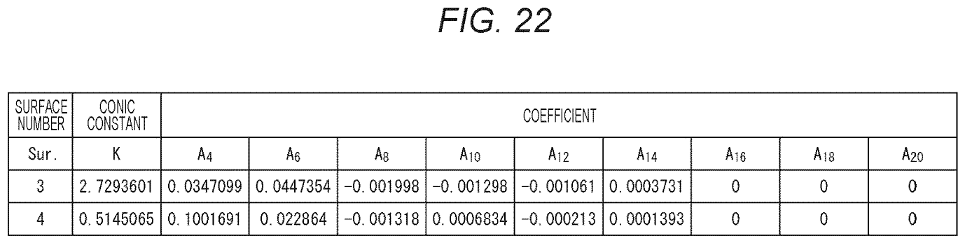

The table of FIG. 22 shows the conic constant K and the coefficient A₂ᵢ in Formula (1) described above as the profile of the aspherical shape of the optical surface 102a or 102b corresponding to each surface number of the optical surfaces 102a and 102b in association with each surface number.

As shown in FIG. 22, the conic constant K of the optical surface 102a with the surface number “3” is 2.7293601. The coefficients A₄, A₆, A₈, A₁₀, A₁₂, and A₁₄ are 0.0347099, 0.0447354, −0.001998, −0.001298, −0.001061, and 0.0003731, respectively. The coefficients A₁₆, A₁₈, and A₂₀ are all 0.

The conic constant K of the optical surface 102b with the surface number “4” is 0.5145065. The coefficients A₄, A₆, A₈, A₁₀, A₁₂, and A₁₄ are 0.1001691, 0.022864, −0.001318, 0.0006834, −0.000213, and 0.0001393, respectively. The coefficients A₁₆, A₁₈, and A₂₀ are all 0.

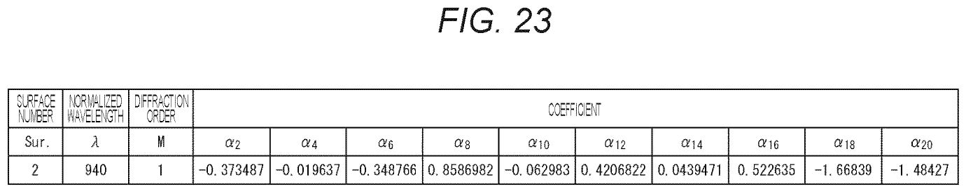

The table of FIG. 23 shows the normalized wavelength λ, the diffraction order M, and the coefficient α₂ᵢ in Formula (2) described above as the phase profile of the metasurface 112 arranged on the optical surface 101b in association with the surface number of the optical surface 101b.

As shown in FIG. 23, the normalized wavelength λ of the metasurface 112 arranged on the optical surface 101b with the surface number “2” is 940, the diffraction order M is 1, and the coefficients α₂, α₄, α₆, α₈, α₁₀, α₁₂, α₁₄, α₁₆, α₁₈, and α₂₀ are −0.373487, −0.019637, −0.348766, 0.8586982, −0.062983, 0.4206822, 0.0439471, 0.522635, −1.66839, and −1.48427, respectively.

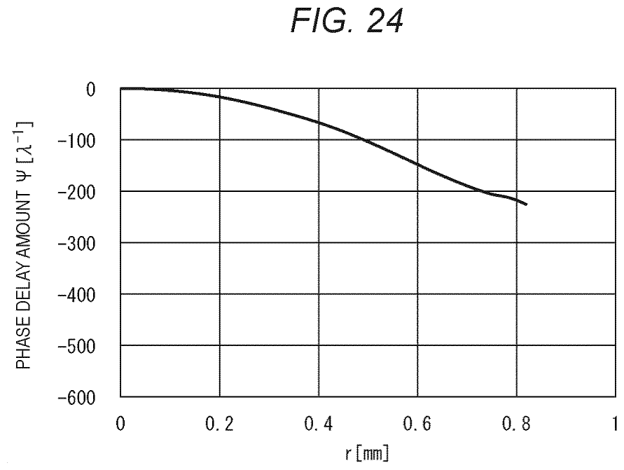

The graph of FIG. 24 shows a profile of the metasurface 112.

As shown in FIG. 24, when the distance r from the optical axis is in a range from 0 mm to around 0.8 mm, the phase delay amount ψ changes from 0 to around −200 such that the phase delay amount ψ increases in the negative direction as the distance r increases.

### <Third Example of Spherical Aberration, Field Curvature, and Distortion Aberration>

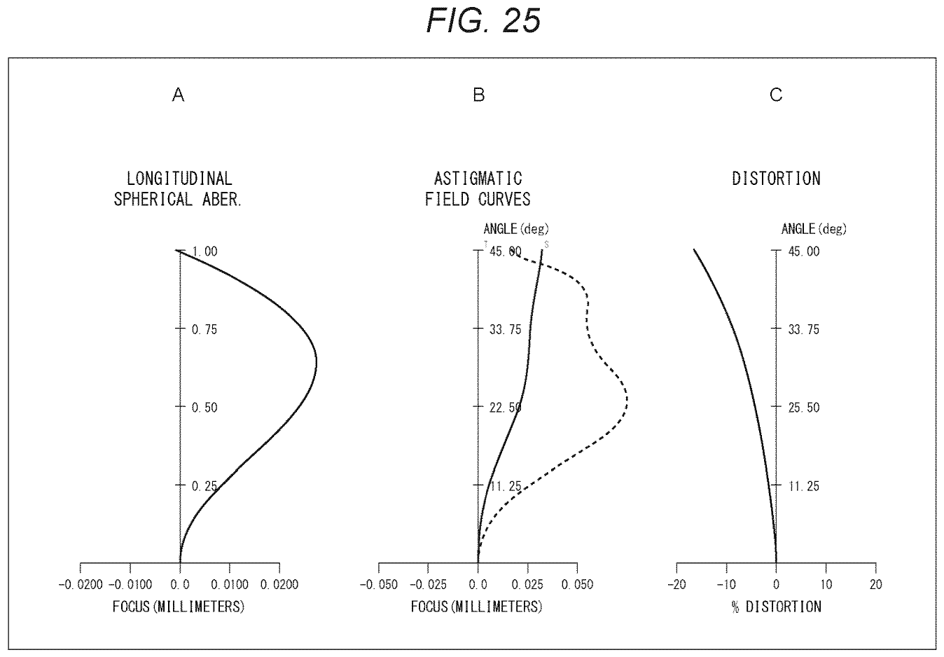

FIG. 25 is a diagram showing an example of spherical aberration, field curvature, and distortion aberration generated in the lens optical system 25 having the features of FIGS. 21 to 24.

A of FIG. 25 is a graph showing the spherical aberration in the longitudinal direction generated in the lens optical system 25 having the features of FIGS. 21 to 24, similarly to A of FIG. 13. B of FIG. 25 is a graph showing the field curvature generated in the lens optical system 25 having the features of FIGS. 21 to 24, similarly to B of FIG. 13. C of FIG. 25 is a graph showing distortion aberration generated in the lens optical system 25 having the features of FIGS. 21 to 24, similarly to C of FIG. 13.

The spherical aberration shown in A of FIG. 25 is larger than the spherical aberration shown in A of FIG. 13 or A of FIG. 19. The field curvature shown in B of FIG. 25 is larger than the field curvature shown in B of FIG. 13 or B of FIG. 19. Here, as described above, the FOV is 90 degrees in the specifications of FIG. 20, but is 154 degrees in the specifications of FIG. 8, and is 100 degrees in the specifications of FIG. 14. Therefore, in a case where the FOV is 100 degrees or more, it can be seen that the lens optical system 25 can further reduce spherical aberration and field curvature, and further improve optical performance. Therefore, the field of view (FOV) is desirably 100 degrees or more.

As the imaging range is wider, the size of the light receiving surface 31a can be enlarged, and the resolution of the captured image, that is, the number of pixels can be increased. Therefore, in consideration of an assembly error and the like of each module of the imaging apparatus 10, an imaging range in which the maximum image height is about 1 mm is desirable.

In the lens optical system 25 of the specifications of FIGS. 8, 14, and 20, the interval between the aperture stop 111 and the metasurface 112 is 0.8 mm, but is not limited to 0.8 mm as long as it is larger than 0.6 mm. In a case where the interval between the aperture stop 111 and the metasurface 112 is larger than 0.6 mm, the off-axis light flux can be more separated, and the aberration of the off-axis light flux can be more easily corrected.

Note that, in the above description, the metasurface 112 is configured by forming one nanostructure 132 on the substrate 131, but may be configured by forming a plurality nanostructures.

### <Another Structural Example of Meta Surface>

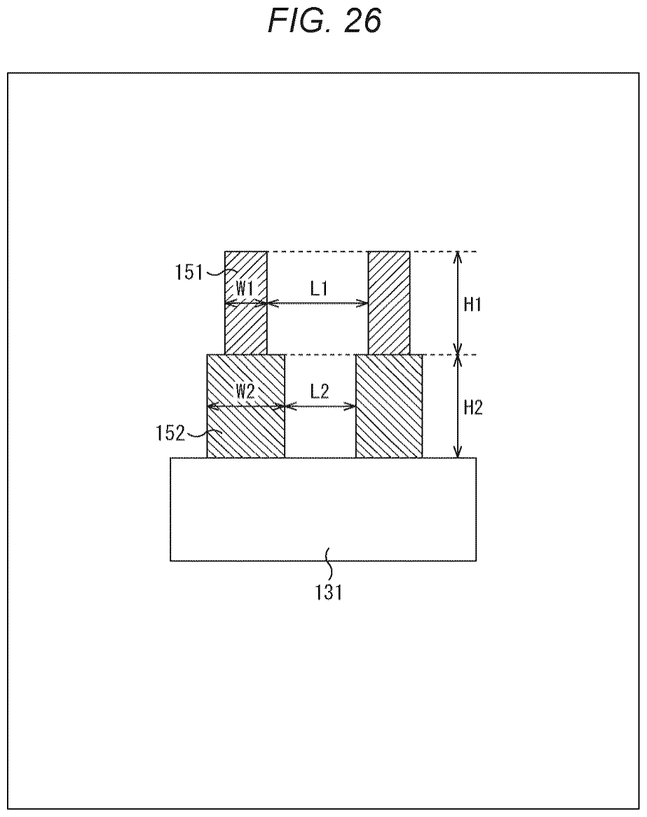

A structural example of the metasurface 112 including the two nanostructures will be described with reference to FIG. 26.

FIG. 26 is a cross-sectional view of a region in which each nanostructure is arranged in the metasurface 112 including two nanostructures.

In the metasurface 112 of FIG. 26, portions corresponding to those of the metasurface 112 of FIG. 7 are denoted by the same reference numerals. Therefore, description of the portion will be appropriately omitted, and description will be given focusing on a portion different from the metasurface 112 in FIG. 7. The metasurface 112 of FIG. 26 is different from the metasurface 112 of FIG. 7 in that two nanostructures are formed on a substrate 131, and is configured similarly to the metasurface 112 of FIG. 7 in other respects.

In the example of FIG. 26, both an upper nanostructure 151 and a lower nanostructure 152 have a cylindrical shape. Thus, as shown in FIG. 26, the cross-sectional shapes of both the nanostructures 151 and 152 are rectangular. The shapes of the nanostructures 151 and 152 are not limited to a cylindrical shape similarly to the nanostructures 132, and the nanostructures 151 and 152 may be hollow. The materials of the nanostructures 151 and 152 may be the same or different.

The light incident on the metasurface 112 is, for example, incident on the nanostructure 151 to perform phase modulation and the like, and then incident on the nanostructure 152 to further perform phase modulation and the like. The phase delay amount in the metasurface 112 can be controlled by adjusting the height H1 and the width W1 of the nanostructure 151, the distance L1 between the two adjacent nanostructures 151, the height H2 and the width W2 of the nanostructure 152, the distance L2 between the two adjacent nanostructures 152, and the like. The widths W1 and W2 and the distances L1 and L2 are set within a range of, for example, 50 to 750 nm, and the heights H1 and H2 are set within a range of, for example, 50 to 1000 nm.

### Second Embodiment

### <Configuration Example of Lens Optical System>

Since the second embodiment of the imaging apparatus to which the present technology is applied is configured similarly to the first embodiment except for the lens optical system, only the lens optical system will be described below.

FIG. 27 is a side view showing a configuration example of the lens optical system in the second embodiment of the imaging apparatus to which the present technology is applied.

In a lens optical system 211 of FIG. 27, portions corresponding to those of the lens optical system 25 of FIG. 4 are denoted by the same reference numerals. Therefore, description of the portion will be appropriately omitted, and description will be given focusing on a portion different from the lens optical system 25. The lens optical system 211 is different from the lens optical system 25 in that an optical lens 221, an aperture stop 222, an optical lens 223, and an optical element 224 are provided instead of the metalens 101 and the optical lens 102, and is configured similarly to the lens optical system 25 except for this.

Specifically, the lens optical system 211 includes an optical lens 221, an aperture stop 222, an optical lens 223, an optical element 224, and a band pass filter 103 in this order from the incident side of light (left side in FIG. 27).

The optical lens 221 (first lens) has negative refractive power in the vicinity of the optical axis indicated by an alternate long and short dash line in FIG. 27. The aperture stop 222 is arranged between the optical lens 221 and the optical lens 223 so as to be in contact with the optical lens 223. The aperture stop 222 limits light incident on the optical lens 223 via the optical lens 221.

The optical lens 223 (second lens) has positive refractive power in the vicinity of the optical axis. The optical element 224 has positive refractive power in the vicinity of the optical axis. An optical surface 224a (first optical surface) on the incident side of light of the optical element 224 has a flat surface or a curved surface. The metasurface 231 having a structure similar to the metasurface 112 is arranged on an optical surface 224b (second optical surface) on the emission side of light of the optical element 224.

The light from the subject is incident on the optical surface 221a on the incident side of light of the optical lens 221, and is emitted from an optical surface 221b on the emission side of light to the aperture stop 222. The light incident on the aperture stop 222 and limited is emitted from an optical surface 223b on the emission side of light to an optical surface 224a via an optical surface 223a on the incident side of light of the optical lens 223. The light incident on the optical surface 224a is emitted via the optical surface 224b, the optical surface 103a, and the optical surface 103b. The light emitted from the lens optical system 211 in this manner is condensed on the light receiving surface 31a via the glass substrate 23, the adhesive 22, and the on-chip lens 32.

As described above, the lens optical system 211 realizes a wide-angle lens optical system by the optical element 224 in which the metasurface 231 is arranged and the two optical lenses 221 and 223. Therefore, the size can be reduced as compared with a case where the wide-angle lens optical system is realized only by the optical lens.

Since the optical lens 223 and the optical element 224 have positive refractive power, it is possible to realize the lens optical system 211 that is thin and has a small F value as compared with a case where either one has negative refractive power. Since the optical lens 221 has negative refractive power and the optical lens 223 and the optical element 224 have positive refractive power, the large-diameter lens optical system 211 can be realized.

Since the metasurface 231 is arranged on the optical surface 224b on the emission side of light of the optical element 224, it is possible to separate the on-axis light flux and the off-axis light flux incident on the metasurface 231. As a result, the aberration of the off-axis light flux can be easily corrected in the metasurface 231, and the optical performance can be improved.

Since the optical lens 223 and the optical element 224 have positive refractive power in the vicinity of the optical axis, a necessary refraction amount and a necessary phase delay amount can be shared by the optical lens 223 and the optical element 224. As a result, the refraction amount in the metasurface 231 arranged in the optical element 224, that is, the phase delay amount can be reduced. As a result, a decrease in efficiency in the metasurface 231 can be suppressed, and the optical performance can be improved.

Since the aperture stop 222 is provided between the optical lenses 221 and 223, correction of spherical aberration by the optical lens 223 is facilitated, and the refraction amount in the metasurface 231 can be further reduced. As a result, it is possible to contribute to suppression of a decrease in efficiency in the metasurface 231.

### <Specification Example of Lens Optical System>

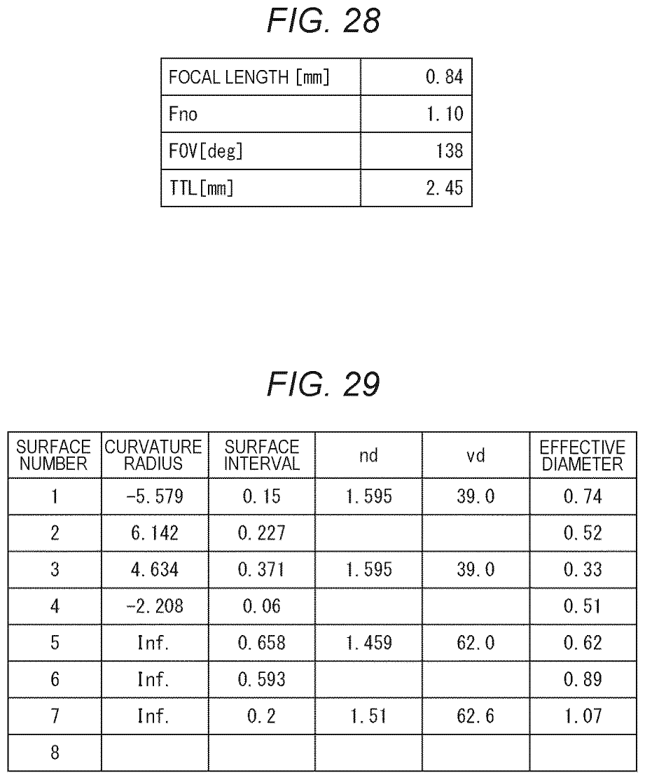

FIG. 28 is a diagram showing a specification example of the lens optical system 211 in FIG. 27.

In the specifications of FIG. 28, the focal length is 0.84 mm, the F-number is 1.10, the FOV is 138 degrees, and the total length TTL of the lens optical system 211 is 2.45. Therefore, 1/(Fno×TTL) is about 0.371.

### <Characteristic Examples of Each Optical Surface>

Next, examples of features of each optical surface of the lens optical system 211 designed on the basis of the specifications of FIG. 28 will be described with reference to FIGS. 29 to 32.

In FIGS. 29 to 31, surface numbers 1 to 8 are sequentially assigned to the optical surfaces 221a, 221b, 223a, 223b, 224a, 224b, 103a, and 103b.

The table of FIG. 29 shows the curvature radius, the surface interval, the refractive index nd, the Abbe number vd, and the effective diameter of the optical surfaces 221a, 221b, 223a, 223b, 224a, 224b, 103a, or 103b corresponding to each surface number in association with each surface number.

As shown in FIG. 29, the curvature radius of the optical surface 221a with the surface number “1” is −5.579, the surface interval with the optical surface 221b is 0.15 mm, the refractive index nd is 1.595, vd is 39.0, and the effective diameter is 0.74 mm. The curvature radius of the optical surface 221b with the surface number “2” is 6.142, the surface interval with the optical surface 223a is 0.227 mm, and the effective diameter is 0.52 mm.

The curvature radius of the optical surface 223a with the surface number “3” is 4.634, the surface interval with the optical surface 223b is 0.371 mm, the refractive index nd is 1.595, vd is 39.0, and the effective diameter is 0.33 mm. The curvature radius of the optical surface 223b with the surface number “4” is −2.208, the surface interval with the optical surface 224a is 0.06 mm, and the effective diameter is 0.51 mm.

The curvature radius of the optical surface 224a with the surface number “5” is infinite, the surface interval with the optical surface 224b on which the metasurface 231 is arranged is 0.658 mm, the refractive index nd is 1.459, vd is 62.0, and the effective diameter is 0.62 mm. Therefore, the interval between the aperture stop 222 in contact with the optical surface 223a and the metasurface 231 is 1.089 (=0.371+0.06+0.658) mm.

The curvature radius of the optical surface 224b with the surface number “6” is infinite, the surface interval with the optical surface 103a is 0.593 mm, and the effective diameter is 0.89 mm. The curvature radius of the optical surface 103a with the surface number “7” is infinite, the surface interval with the optical surface 103b is 0.2 mm, the refractive index nd is 1.51, vd is 62.6, and the effective diameter is 1.07 mm.

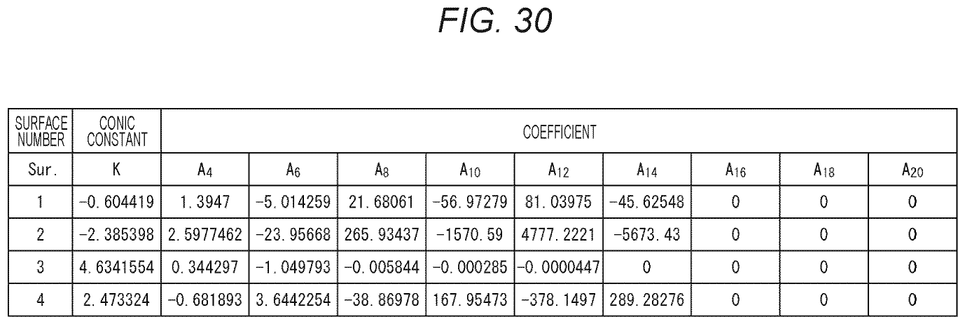

The table of FIG. 30 shows the conic constant K and the coefficient A₂ᵢ in Formula (1) described above as the profile of the aspherical shape of the optical surface 221a, 221b, 223a, or 224b corresponding to each surface number of the optical surfaces 221a, 221b, 223a, and 224b in association with each surface number.

As shown in FIG. 30, the conic constant K of the optical surface 221a with the surface number “1” is −0.604419. The coefficients A₄, A₆, A₈, A₁₀, A₁₂, and A₁₄ are 1.3947, −5.014259, 21.68061, −56.97279, 81.03975, and −45.62548, respectively. The coefficients A₁₆, A₁₈, and A₂₀ are all 0.

The conic constant K of the optical surface 221b with the surface number “2” is −2.385398. The coefficients A₄, A₆, A₈, A₁₀, A₁₂, and A₁₄ are 2.5977462, −23.95668, 265.93437, −1570.59, 4777.2221, and −5673.43, respectively. A₁₆, A₁₈, and A₂₀ are all 0.

The conic constant K of the optical surface 223a with the surface number “3” is 4.6341554. The coefficients A₄, A₆, A₈, A₁₀, A₁₂, and A₁₄ are 0.344297, −1.049793, −0.005844, −0.000285, and −0.0000447, respectively. A₁₄, A₁₆, A₁₈, and A₂₀ are all 0.

The conic constant K of the optical surface 223b with the surface number “4” is 2.473324. The coefficients A₄, A₆, A₈, A₁₀, A₁₂, and A₁₄ are −0.681893, 3.6442254, −38.86978, 167.95473, −378.1497, and 289.28276, respectively. A₁₆, A₁₈, and A₂₀ are all 0.

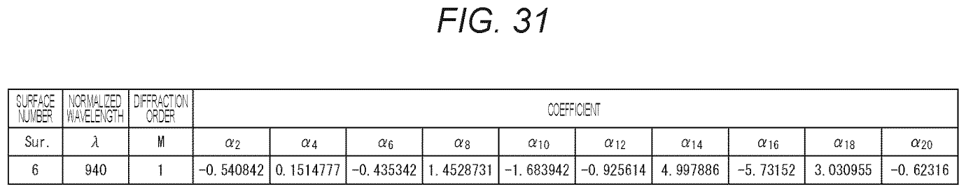

The table of FIG. 31 shows the normalized wavelength λ, the diffraction order M, and the coefficient α₂ᵢ in Formula (2) described above as the phase profile of the metasurface 231 arranged on the optical surface 224b in association with the surface number of the optical surface 224b.

As shown in FIG. 31, the normalized wavelength λ of the metasurface 231 arranged on the optical surface 224b with the surface number “6” is 940, and the diffraction order M is 1. The coefficients α₂, α₄, α₆, α₈, α₁₀, α₁₂, α₁₄, α₁₆, α₁₈, and α₂₀ are −0.540842, 0.1514777, −0.435342, 1.4528731, −1.683942, −0.925614, 4.997886, −5.73152, 3.030955, and −0.62316, respectively.

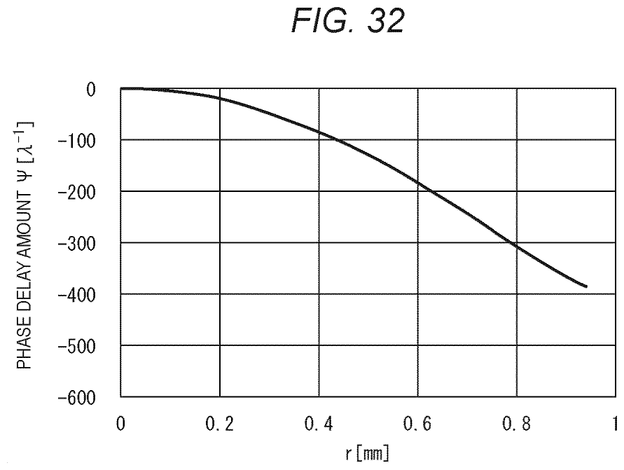

The graph of FIG. 32 shows a profile of the metasurface 231.

As shown in FIG. 32, when the distance r from the optical axis is in a range from 0 mm to around 0.9 mm, the phase delay amount ψ changes from 0 to around −400 such that the phase delay amount ψ increases in the negative direction as the distance r increases.

### <Examples of Spherical Aberration, Field Curvature, and Distortion Aberration>

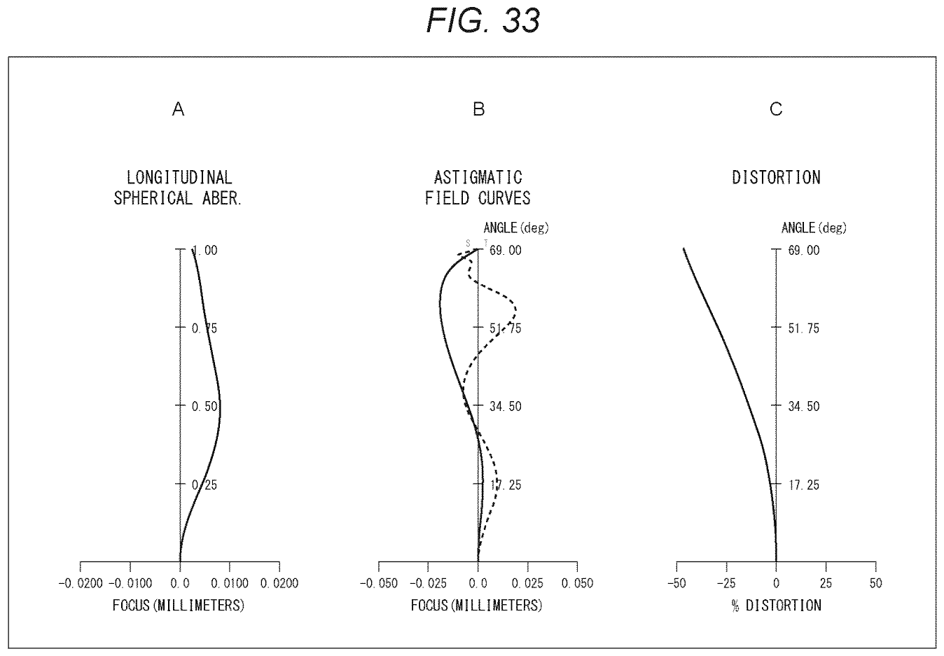

FIG. 33 is a diagram showing an example of spherical aberration, field curvature, and distortion aberration generated in the lens optical system 211 having the features of FIGS. 29 to 32.

A of FIG. 33 is a graph showing the spherical aberration in the longitudinal direction generated in the lens optical system 211 having the features of FIGS. 29 to 32, similarly to A of FIG. 13. B of FIG. 33 is a graph showing the field curvature generated in the lens optical system 211 having the features of FIGS. 29 to 32, similarly to B of FIG. 13. C of FIG. 33 is a graph showing distortion aberration generated in the lens optical system 211 having the features of FIGS. 29 to 32, similarly to C of FIG. 13.

Note that, although illustration is omitted, also in the second embodiment, similarly to the first embodiment, in a case where the FOV is 100 degrees or more, spherical aberration and field curvature of the lens optical system 211 can be further reduced, and optical performance can be further improved. Therefore, the FOV is desirably 100 degrees or more.

In the lens optical system 211 of the specifications of FIG. 28, the interval between the aperture stop 222 and the metasurface 231 is 1.089 mm, but is not limited to 1.089 mm as long as it is larger than 0.6 mm. In a case where the interval between the aperture stop 222 and the metasurface 231 is larger than 0.6 mm, the off-axis light flux can be more separated from the on-axis light flux, and the aberration of the off-axis light flux can be more easily corrected.

### Third Embodiment

### <Configuration Example of Lens Optical System>

Since a third embodiment of the imaging apparatus to which the present technology is applied is configured similarly to the first embodiment except for the lens optical system, only the lens optical system will be described below.

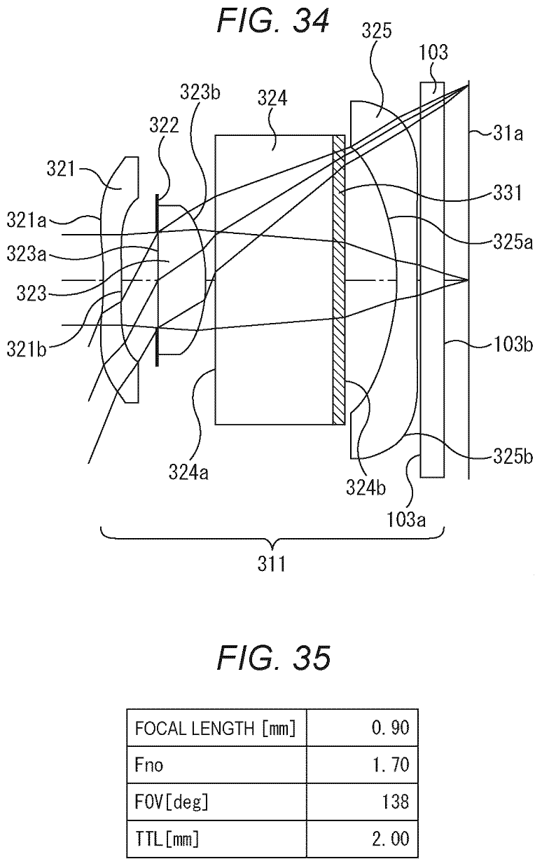

FIG. 34 is a side view showing a configuration example of the lens optical system in the third embodiment of the imaging apparatus to which the present technology is applied.

In a lens optical system 311 of FIG. 34, portions corresponding to those of the lens optical system 25 of FIG. 4 are denoted by the same reference numerals. Therefore, description of the portion will be appropriately omitted, and description will be given focusing on a portion different from the lens optical system 25. The lens optical system 311 is different from the lens optical system 25 in that an optical lens 321, an aperture stop 322, an optical lens 323, an optical element 324, and an optical lens 325 are provided instead of the metalens 101 and the optical lens 102, and is configured similarly to the lens optical system 25 except for this.

Specifically, the lens optical system 311 includes an optical lens 321 (first lens), an aperture stop 322, an optical lens 323, an optical element 324, an optical lens 325 (third lens), and a band pass filter 103 in order from an incident side of light (left side in FIG. 34).

The optical lens 321 has a function of securing the amount of off-axis light flux and correcting field curvature and distortion aberration. The aperture stop 322 is arranged between the optical lens 321 and the optical lens 323 so as to be in contact with, for example, the optical lens 323. In the example of FIG. 34, the aperture stop 322 is arranged so as to be in contact with the optical lens 323, but may be arranged away from the optical lens 321 as long as it is arranged between the optical lens 323 and the optical lens 323. The aperture stop 322 limits light incident on the optical lens 321 via the optical lens 323.

The optical lens 323 (second lens) has a positive refractive power in the vicinity of the optical axis indicated by an alternate long and short dash line in FIG. 34. The optical element 324 has positive refractive power in the vicinity of the optical axis. An optical surface 324a (first optical surface) on the incident side of light of the optical element 324 has a flat surface or a curved surface. A metasurface 331 having positive refractive power in the vicinity of the optical axis is arranged on an optical surface 324b (second optical surface) on the emission side of light of the optical element 324. The metasurface 331 has a structure similar to that of the metasurface 112. The optical lens 325 has a function of securing the amount of off-axis light flux and correcting field curvature and distortion aberration.

The light from the subject is incident on an optical surface 321a on the incident side of light of the optical lens 321, and is emitted from an optical surface 321b on the emission side of light to the aperture stop 322. The light incident on the aperture stop 322 and limited is incident on an optical surface 323a on the incident side of light of the optical lens 323, and is emitted to an optical surface 325a on the incident side of the optical lens 325 via an optical surface 323b on the emission side of light, an optical surface 324a, and an optical surface 324b. The light incident on the optical surface 325a is emitted through an optical surface 325b on the emission side of the optical lens 325, the optical surface 103a, and the optical surface 103b. The light emitted from the lens optical system 311 in this manner is condensed on the light receiving surface 31a via the glass substrate 23, the adhesive 22, and the on-chip lens 32.

As described above, the lens optical system 311 realizes a wide-angle lens optical system by the optical element 324 on which the metasurface 331 is arranged and the three optical lenses 321,323 and 325. Therefore, the size can be reduced as compared with a case where the wide-angle lens optical system is realized only by the optical lens.

Since the optical lens 323 and the metasurface 331 have positive refractive power in the vicinity of the optical axis, it is possible to realize the lens optical system 311 that is thin and has a small F value as compared with a case where either one has negative refractive power. Since the optical lenses 321 and 325 have a function of correcting field curvature and distortion aberration, the field curvature and distortion aberration can be reduced and optical performance can be improved.

Since the optical lens 323 and the metasurface 331 have positive refractive power, a necessary refraction amount and a necessary phase delay amount can be shared by the optical lens 323 and the metasurface 331. As a result, the phase delay amount in the metasurface 331 can be reduced. As a result, a decrease in efficiency in the metasurface 331 can be suppressed, and the optical performance can be improved.

Since the aperture stop 322 is provided between the optical lenses 321 and 323, correction of spherical aberration by the optical lens 323 is facilitated, and the refraction amount in the metasurface 331 can be further reduced. As a result, it is possible to contribute to suppression of a decrease in efficiency in the metasurface 331.

### <Specification Example of Lens Optical System>

FIG. 35 is a diagram showing a specification example of the lens optical system 311 in FIG. 34.

In the specifications of FIG. 35, the focal length is 0.90 mm, the F-number is 1.70, the FOV is 138 degrees, and the total length TTL of the lens optical system 311 is 2.00. Therefore, 1/(Fno×TTL) is about 0.294.

### <Characteristic Examples of Each Optical Surface>

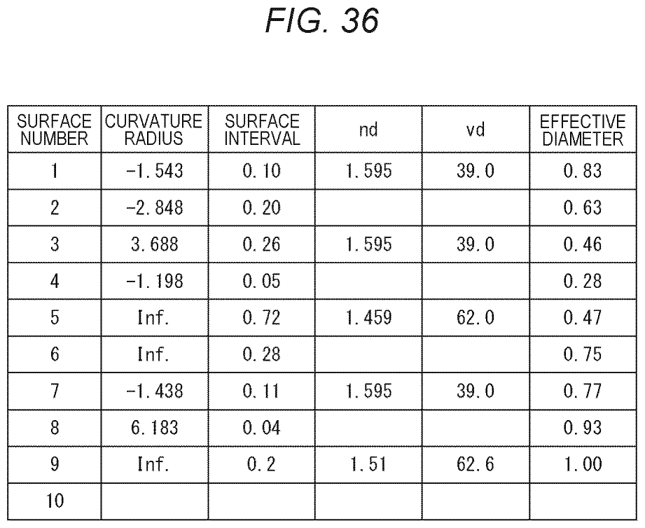

Next, examples of features of each optical surface of the lens optical system 311 designed on the basis of the specifications of FIG. 35 will be described with reference to FIGS. 36 to 39.

In FIGS. 36 to 38, surface numbers 1 to 10 are sequentially assigned to the optical surfaces 321a, 321b, 323a, 323b, 324a, 324b, 325a, 325b, 103a, and 103b.

The table of FIG. 36 shows the curvature radius, the surface interval, the refractive index nd, the Abbe number vd, and the effective diameter of the optical surface 321a, 321b, 323a, 323b, 324a, 324b, 325a, 325b, 103a, or 103b corresponding to each surface number in association with each surface number.

As shown in FIG. 36, the curvature radius of the optical surface 321a with the surface number “1” is −1.543, the surface interval with the optical surface 321b is 0.10 mm, the refractive index nd is 1.595, vd is 39.0, and the effective diameter is 0.83 mm. The curvature radius of the optical surface 321b with the surface number “2” is −2.848, the surface interval with the optical surface 323a is 0.20 mm, and the effective diameter is 0.63 mm.

The curvature radius of the optical surface 323a with the surface number “3” is 3.688, the surface interval with the optical surface 323b is 0.26 mm, the refractive index nd is 1.595, vd is 39.0, and the effective diameter is 0.46 mm. The curvature radius of the optical surface 323b with the surface number “4” is −1.198, the surface interval with the optical surface 324a is 0.05 mm, and the effective diameter is 0.28 mm.

The curvature radius of the optical surface 324a with the surface number “5” is infinite, the surface interval with the optical surface 324b on which the metasurface 331 is arranged is 0.72 mm, the refractive index nd is 1.459, vd is 62.0, and the effective diameter is 0.47 mm. Therefore, the interval between the aperture stop 322 in contact with the optical surface 323a and the metasurface 331 is 1.03 (=0.26+0.05+0.72) mm.

The curvature radius of the optical surface 324b with the surface number “6” is infinite, the surface interval with the optical surface 325a is 0.28 mm, and the effective diameter is 0.75 mm. The curvature radius of the optical surface 325a with the surface number “7” is −1.438, the surface interval with the optical surface 325b is 0.11 mm, the refractive index nd is 1.595, vd is 39.0, and the effective diameter is 0.77 mm.

The curvature radius of the optical surface 325b with the surface number “8” is 6.183, the surface interval with the optical surface 103a is 0.04 mm, and the effective diameter is 0.93 mm. The curvature radius of the optical surface 103a with the surface number “9” is infinite, the surface interval with the optical surface 103b is 0.2 mm, the refractive index nd is 1.51, vd is 62.6, and the effective diameter is 1.00 mm.

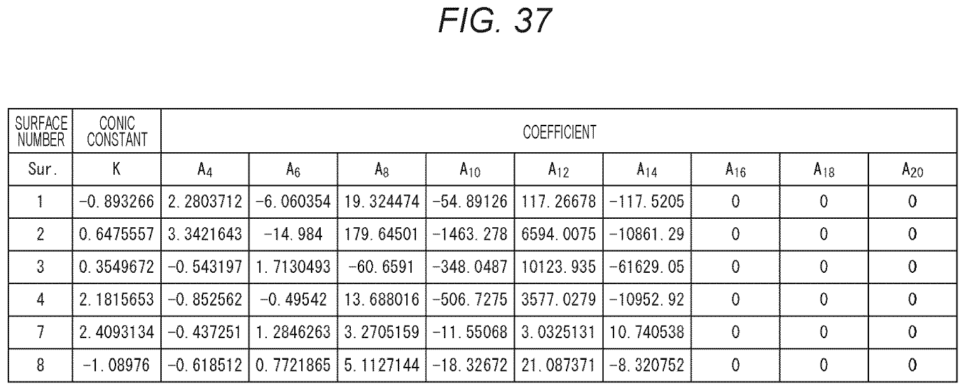

The table of FIG. 37 shows the conic constant K and the coefficient A₂ᵢ in Formula (1) described above as the profile of the aspherical shape of the optical surface 321a, 321b, 323a, 323b, 325a, or 325b corresponding to each surface number of the optical surfaces 321a, 321b, 323a, 323b, 325a, and 325b in association with each surface number.

As shown in FIG. 37, the conic constant K of the optical surface 321a with the surface number “1” is −0.893266. The coefficients A₄, A₆, A₈, A₁₀, A₁₂, and A₁₄ are 2.2803712, −6.060354, 19.324474, −54.89126, 117.26678, and −117.5205, respectively. The coefficients A₁₆, A₁₈, and A₂₀ are all 0.

The conic constant K of the optical surface 321b with the surface number “2” is 0.647557. The coefficients A₄, A₆, A₈, A₁₀, A₁₂, and A₁₄ are 3.3421643, −14.984, 179.64501, −1436.278, 6594.0075, and −10861.29, respectively. The coefficients A₁₆, A₁₈, and A₂₀ are all 0.

The conic constant K of the optical surface 323a with the surface number “3” is 0.3549672. The coefficients A₄, A₆, A₈, A₁₀, A₁₂, and A₁₄ are −0.543197, 1.7130493, −60.6591, −348.0487, 10123.935, and −61629.05, respectively. A₁₆, A₁₈, and A₂₀ are all 0.

The conic constant K of the optical surface 323b with the surface number “4” is 2.1815653. The coefficients A₄, A₆, A₈, A₁₀, A₁₂, and A₁₄ are −0.852562, −0.49542, 13.688016, −506.7275, 3577.0279, and −10952.92, respectively. A₁₆, A₁₈, and A₂₀ are all 0.

The conic constant K of the optical surface 325a with the surface number “7” is 2.4093134. The coefficients A₄, A₆, A₈, A₁₀, A₁₂, and A₁₄ are −0.437251, 1.2846263, 3.2705159, −11.55068, 3.0325131, and 10.740538, respectively. A₁₆, A₁₈, and Azo are all 0.

The conic constant K of the optical surface 325b with the surface number “8” is −1.08976. The coefficients A₄, A₆, A₈, A₁₀, A₁₂, and A₁₄ are −0.618512, 0.7721865, 5.1127144, −18.32672, 21.087371, and −8.320752, respectively. A₁₆, A₁₈, and A₂₀ are all 0.

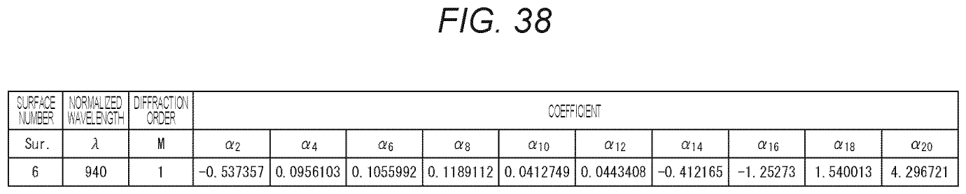

The table of FIG. 38 shows the normalized wavelength λ, the diffraction order M, and the coefficient α₂ᵢ in Formula (2) described above as the phase profile of the metasurface 331 arranged on the optical surface 324b in association with the surface number of the optical surface 324b.

As shown in FIG. 38, the normalized wavelength λ of the metasurface 331 arranged on the optical surface 324b with the surface number “6” is 940, and the diffraction order M is 1. The coefficients α₂, α₄, α₆, α₈, α₁₀, α₁₂, α₁₄, α₁₆, α₁₈, and α₂₀ are −0.537357, 0.0956103, 0.1055992, 0.1189112, 0.0412749, 0.0443408, −0.412165, −1.25273, 1.540013, and 4.296721, respectively.

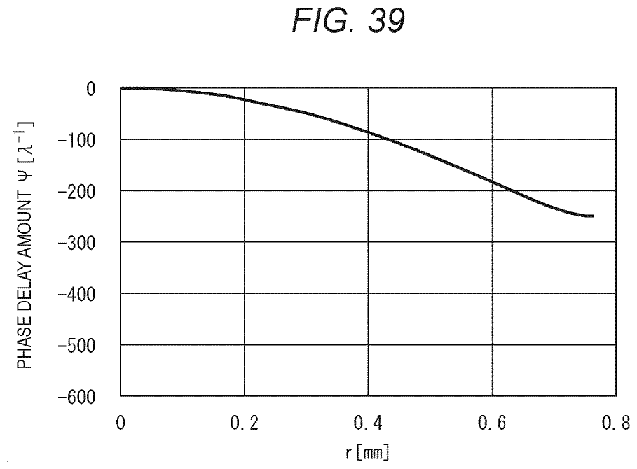

The graph of FIG. 39 shows a profile of the metasurface 331.

As shown in FIG. 39, when the distance r from the optical axis is in a range from 0 mm to around 0.8 mm, the phase delay amount ψ changes from 0 to around −250 such that the phase delay amount w increases in the negative direction as the distance r increases.

### <Examples of Spherical Aberration, Field Curvature, and Distortion Aberration>

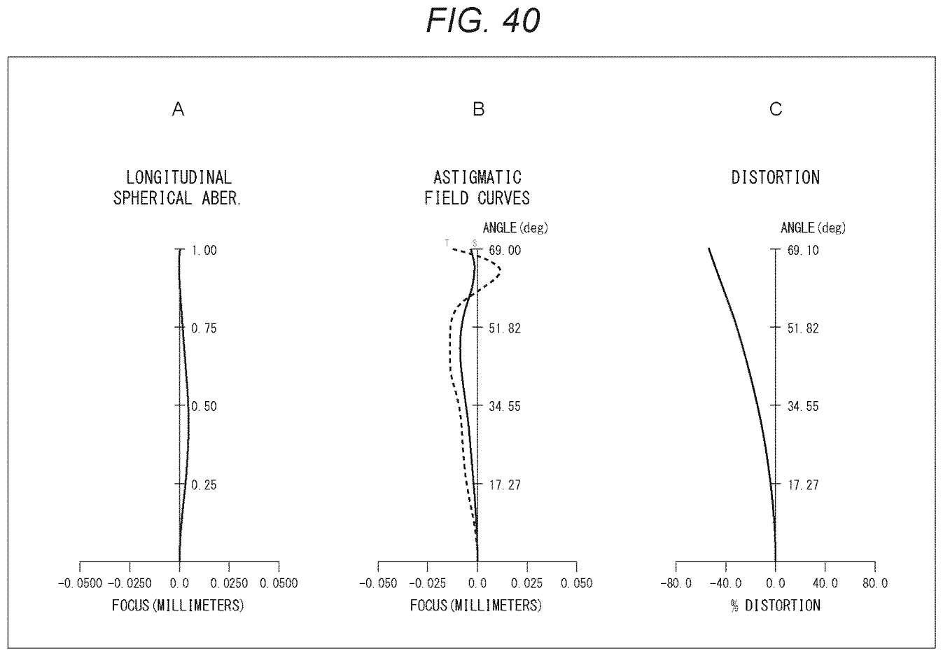

FIG. 40 is a diagram showing an example of spherical aberration, field curvature, and distortion aberration generated in the lens optical system 311 having the features of FIGS. 36 to 39.

A of FIG. 40 is a graph showing the spherical aberration in the longitudinal direction generated in the lens optical system 311 having the features of FIGS. 36 to 39, similarly to A of FIG. 13. B of FIG. 40 is a graph showing the field curvature generated in the lens optical system 311 having the features of FIGS. 36 to 39, similarly to B of FIG. 13. C of FIG. 40 is a graph showing distortion aberration generated in the lens optical system 311 having the features of FIGS. 36 to 39, similarly to C of FIG. 13.

Note that, although illustration is omitted, also in the third embodiment, similarly to the first embodiment, in a case where the FOV is 100 degrees or more, spherical aberration and field curvature of the lens optical system 311 can be further reduced, and optical performance can be further improved. Therefore, the FOV is desirably 100 degrees or more.

In the lens optical system 311 of the specifications of FIG. 35, the interval between the aperture stop 322 and the metasurface 331 is 1.03 mm, but is not limited to 1.03 mm as long as it is larger than 0.6 mm. In a case where the interval between the aperture stop 322 and the metasurface 331 is larger than 0.6 mm, the off-axis light flux can be more separated, and the aberration of the off-axis light flux can be more easily corrected.

### Fourth Embodiment

### <Configuration Example of Lens Optical System>

Since a fourth embodiment of the imaging apparatus to which the present technology is applied is configured similarly to the first embodiment except for the lens optical system, only the lens optical system will be described below.

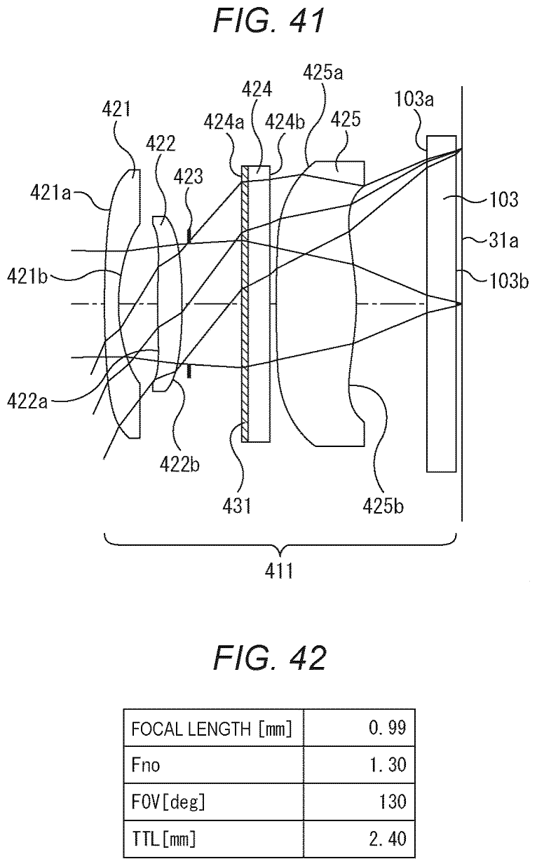

FIG. 41 is a side view showing a configuration example of the lens optical system in the fourth embodiment of the imaging apparatus to which the present technology is applied.

In a lens optical system 411 of FIG. 41, portions corresponding to those of the lens optical system 25 of FIG. 4 are denoted by the same reference numerals. Therefore, description of the portion will be appropriately omitted, and description will be given focusing on a portion different from the lens optical system 25. The lens optical system 411 is different from the lens optical system 25 in that optical lenses 421 and 422, an aperture stop 423, an optical element 424, and an optical lens 425 are provided instead of the metalens 101 and the optical lens 102, and is configured similarly to the lens optical system 25 except for this.

Specifically, the lens optical system 411 includes an optical lens 421 (first lens), an optical lens 422, an aperture stop 423, an optical element 424, an optical lens 425 (third lens), and a band pass filter 103 in order from an incident side of light (left side in FIG. 41).

The optical lens 421 has a function of securing the amount of off-axis light flux and correcting field curvature and distortion aberration. The optical lens 422 (second lens) has positive or negative refractive power in the vicinity of the optical axis indicated by an alternate long and short dash line in FIG. 41. The composite focal length of the optical lens 421 and the optical lens 422 is negative.

The aperture stop 423 is arranged between the optical lens 422 and the optical element 424. The aperture stop 423 limits light incident on the optical element 424 via the optical lens 422. The optical element 424 has positive refractive power in the vicinity of the optical axis. A metasurface 431 having positive refractive power is arranged on an optical surface 424a (second optical surface) on the incident side of light of the optical element 424. The metasurface 431 has a structure similar to that of the metasurface 112. An optical surface 424b (first optical surface) on the emission side of light of the optical element 424 has a flat surface or a curved surface. The optical lens 425 has positive refractive power. The optical lens 425 has a function of securing the amount of off-axis light flux and correcting field curvature and distortion aberration.

The light from the subject is incident on an optical surface 421a on the incident side of light of the optical lens 421, and is emitted from an optical surface 421b on the emission side of light to an optical surface 422a on the incident side of light of the optical lens 422. The light incident on the optical surface 422a is emitted from an optical surface 422b on the emission side of light of the optical lens 422 to the aperture stop 423. The light incident on the aperture stop 423 and limited is emitted to the optical surface 425a on the incident side of light of the optical lens 425 via the optical surfaces 424a and 424b. The light incident on the optical surface 425a is emitted through the optical surface 425b on the emission side of light of the optical lens 425, the optical surface 103a, and the optical surface 103b. The light emitted from the lens optical system 411 in this manner is condensed on the light receiving surface 31a via the glass substrate 23, the adhesive 22, and the on-chip lens 32.

As described above, the lens optical system 411 realizes a wide-angle lens optical system by the optical element 424 on which the metasurface 431 is arranged and the three optical lenses 421, 422 and 425. Therefore, the size can be reduced as compared with a case where the wide-angle lens optical system is realized only by the optical lens. Since the optical lenses 421 and 425 have a function of correcting field curvature and distortion aberration, the field curvature and distortion aberration can be reduced and optical performance can be improved.

Since the composite focal length of the optical lenses 421 and 422 is negative, the incident angle of light incident on the metasurface 431 becomes small. As a result, the refraction amount in the metasurface 431 can be reduced. As a result, a decrease in efficiency in the metasurface 431 can be suppressed, and the optical performance of the lens optical system 411 can be improved.

Since the refractive power of the metasurface 431 and the optical lens 425 is positive, a necessary refraction amount and a necessary phase delay amount can be shared by the metasurface 431 and the optical lens 425. As a result, the phase delay amount in the metasurface 431 can be reduced. As a result, it is possible to contribute to suppression of a decrease in efficiency in the metasurface 431.

### <Specification Example of Lens Optical System>

FIG. 42 is a diagram showing a specification example of the lens optical system 411 in FIG. 41.

In the specifications of FIG. 42, the focal length is 0.99 mm, the F-number is 1.30, the FOV is 130 degrees, and the total length TTL of the lens optical system 411 is 2.40. Therefore, 1/(Fno×TTL) is about 0.321.

### <Characteristic Examples of Each Optical Surface>

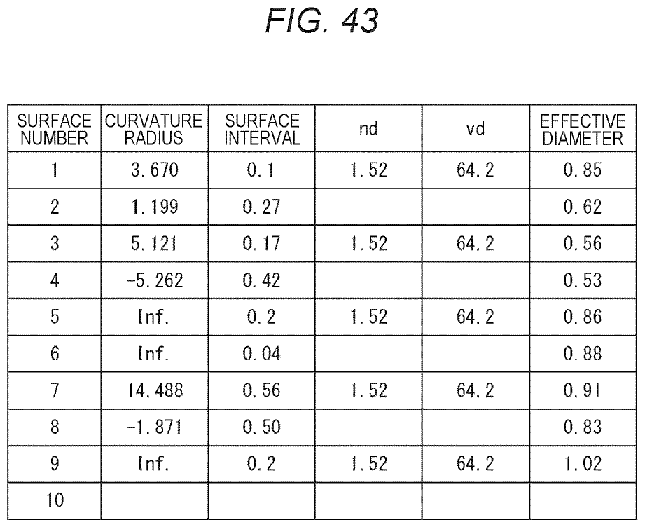

Next, examples of features of each optical surface of the lens optical system 411 designed on the basis of the specifications of FIG. 42 will be described with reference to FIGS. 43 to 46.

In FIGS. 43 to 45, surface numbers 1 to 10 are sequentially assigned to the optical surfaces 421a, 421b, 422a, 422b, 424a, 424b, 425a, 425b, 103a, and 103b.

The table of FIG. 43 shows the curvature radius, the surface interval, the refractive index nd, the Abbe number vd, and the effective diameter of the optical surface 421a, 421b, 422a, 422b, 424a, 424b, 425a, 425b, 103a, or 103b corresponding to each surface number in association with each surface number.

As shown in FIG. 43, the curvature radius of the optical surface 421a with the surface number “1” is 3.670, the surface interval with the optical surface 421b is 0.1 mm, the refractive index nd is 1.52, vd is 64.2, and the effective diameter is 0.85 mm. The curvature radius of the optical surface 421b with the surface number “2” is 1.199, the surface interval with the optical surface 422a is 0.27 mm, and the effective diameter is 0.62 mm.

The curvature radius of the optical surface 422a with the surface number “3” is 5.121, the surface interval with the optical surface 422b is 0.17 mm, the refractive index nd is 1.52, vd is 64.2, and the effective diameter is 0.56 mm. The curvature radius of the optical surface 422b with the surface number “4” is −5.262, the surface interval with the optical surface 424a is 0.42 mm, and the effective diameter is 0.53 mm.

The curvature radius of the optical surface 424a with the surface number “5” is infinite, the surface interval with the optical surface 424b is 0.2 mm, the refractive index nd is 1.52, vd is 64.2, and the effective diameter is 0.86 mm.

The curvature radius of the optical surface 424b with the surface number “6” is infinite, the surface interval with the optical surface 425a is 0.04 mm, and the effective diameter is 0.88 mm. The curvature radius of the optical surface 425a with the surface number “7” is 14.488, the surface interval with the optical surface 425b is 0.56 mm, the refractive index nd is 1.52, vd is 64.2, and the effective diameter is 0.91 mm.

The curvature radius of the optical surface 425b with the surface number “8” is −1.871, the surface interval with the optical surface 103a is 0.50 mm, and the effective diameter is 0.83 mm. The curvature radius of the optical surface 103b with the surface number “9” is infinite, the surface interval with the optical surface 103b is 0.2 mm, the refractive index nd is 1.52, vd is 64.2, and the effective diameter is 1.02 mm.

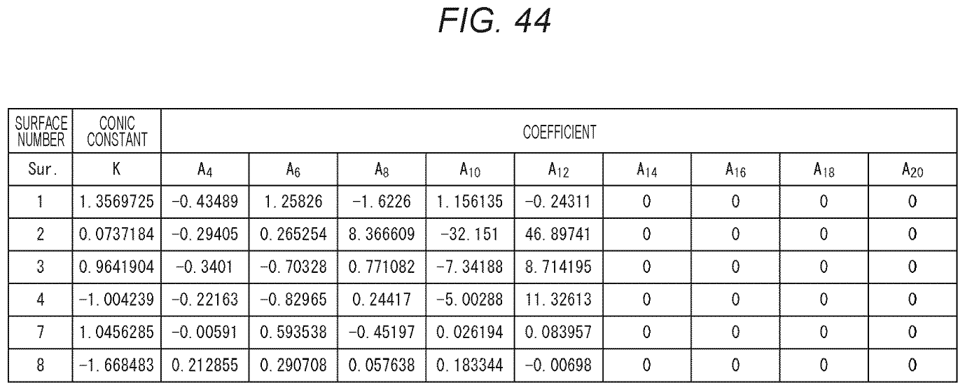

The table of FIG. 44 shows the conic constant K and the coefficient A₂ᵢ in Formula (1) described above as the profile of the aspherical shape of the optical surface 421a, 421b, 422a, 422b, 425a, or 425b corresponding to each surface number of the optical surfaces 421a, 421b, 422a, 422b, 425a, and 425b in association with each surface number.

As shown in FIG. 44, the conic constant K of the optical surface 421a with the surface number “1” is 1.3569725. The coefficients A₄, A₆, A₈, A₁₀, and A₁₂ are −0.43489, 1.25826, −1.6226, 1.156135, and −0.24311, respectively. A₁₄, A₁₆, A₁₈, and A₂₀ are all 0.

The conic constant K of the optical surface 421b with the surface number “2” is 0.0737184. The coefficients A₄, A₆, A₈, A₁₀, and A₁₂ are −0.29405, 0.265254, 8.36609, −32.151, and 46.89741, respectively. A₁₄, A₁₆, A₁₈, and A₂₀ are all 0.

The conic constant K of the optical surface 422a with the surface number “3” is 0.9641904. The coefficients A₄, A₆, A₈, A₁₀, and A₁₂ are −0.3401, −0.70328, 0.771082, −7.34188, and 8.714195, respectively. A₁₄, A₁₆, A₁₈, and A₂₀ are all 0.

The conic constant K of the optical surface 422b with the surface number “4” is −1.004239. The coefficients A₄, A₆, A₈, A₁₀, and A₁₂ are −0.22163, −0.82965, 0.24417, −5.0028, and 11.32613, respectively. A₁₄, A₁₆, A₁₈, and A₂₀ are all 0.

The conic constant K of the optical surface 425a with the surface number “7” is 1.0456285. The coefficients A₄, A₆, A₈, A₁₀, and A₁₂ are −0.00591, 0.593538, −0.45197, 0.026194, and 0.083957, respectively. A₁₄, A₁₆, A₁₈, and A₂₀ are all 0.

The conic constant K of the optical surface 425b with the surface number “8” is −1.668483. The coefficients A₄, A₆, As, A₁₀, and A₁₂ are 0.212855, 0.290708, 0.057638, 0.183344, and −0.00698, respectively. A₁₄, A₁₆, A₁₈, and A₂₀ are all 0.

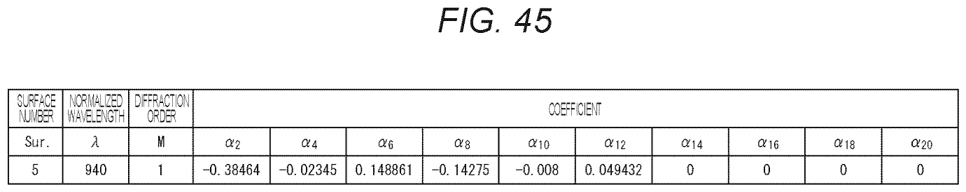

The table of FIG. 45 shows the normalized wavelength λ, the diffraction order M, and the coefficient α₂ᵢ in Formula (2) described above as the phase profile of the metasurface 431 arranged on the optical surface 424a in association with the surface number of the optical surface 424a.

As shown in FIG. 45, the normalized wavelength λ of the metasurface 431 arranged on the optical surface 424a with the surface number “5” is 940, and the diffraction order M is 1. The coefficients α₂, α₄, α₆, as, α₁₀, and α₁₂ are −0.38464, −0.02345, 0.148861, −0.14275, −0.008, and 0.049432, respectively. α₁₄, α₁₆, α₁₈, and α₂₀ are all 0.

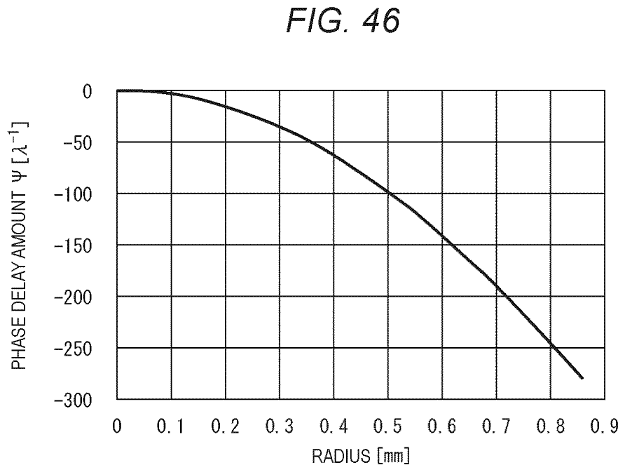

The graph of FIG. 46 shows a profile of the metasurface 431.

As shown in FIG. 46, when the distance r from the optical axis is in a range from 0 mm to around 0.85 mm, the phase delay amount ψ changes from 0 to around −275 such that the phase delay amount ψ increases in the negative direction as the distance r increases.

### <Examples of Spherical Aberration, Field Curvature, and Distortion Aberration>

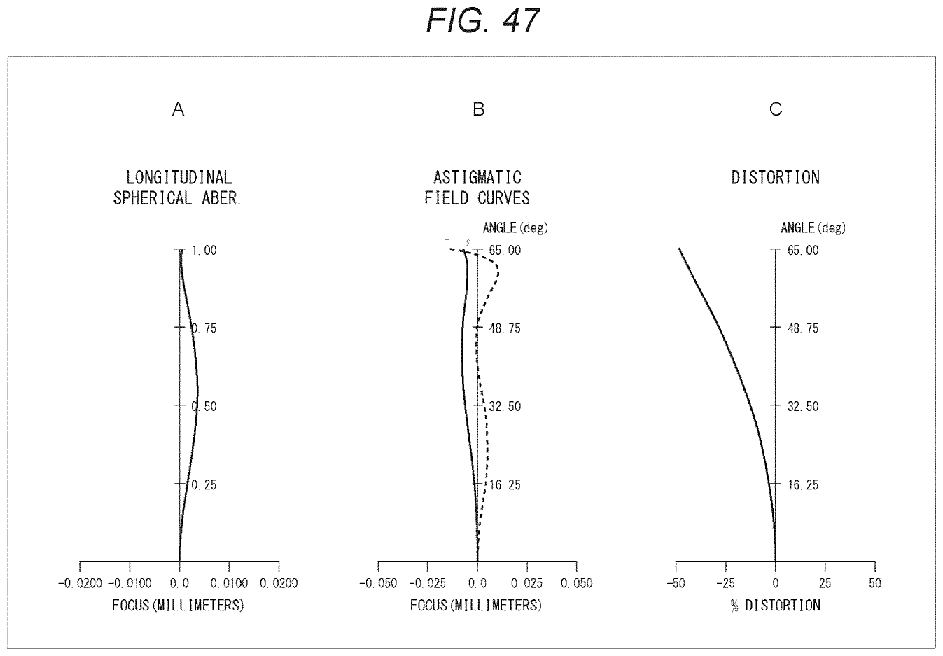

FIG. 47 is a diagram showing an example of spherical aberration, field curvature, and distortion aberration generated in the lens optical system 411 having the features of FIGS. 43 to 46.

A of FIG. 47 is a graph showing the spherical aberration in the longitudinal direction generated in the lens optical system 411 having the features of FIGS. 43 to 46, similarly to A of FIG. 13. B of FIG. 47 is a graph showing the field curvature generated in the lens optical system 411 having the features of FIGS. 43 to 46, similarly to B of FIG. 13. C of FIG. 47 is a graph showing distortion aberration generated in the lens optical system 411 having the features of FIGS. 43 to 46, similarly to C of FIG. 13.

Note that, although illustration is omitted, also in the fourth embodiment, similarly to the first embodiment, in a case where the FOV is 100 degrees or more, spherical aberration and field curvature of the lens optical system 411 can be further reduced, and optical performance can be further improved. Therefore, the FOV is desirably 100 degrees or more.

### Fifth Embodiment

### <Configuration Example of Lens Optical System>

Since a fifth embodiment of the imaging apparatus to which the present technology is applied is configured similarly to the first embodiment except for the lens optical system, only the lens optical system will be described below.

FIG. 48 is a side view showing a configuration example of the lens optical system in the fifth embodiment of the imaging apparatus to which the present technology is applied.

In a lens optical system 511 of FIG. 48, portions corresponding to those of the lens optical system 25 of FIG. 4 are denoted by the same reference numerals. Therefore, description of the portion will be appropriately omitted, and description will be given focusing on a portion different from the lens optical system 25. The lens optical system 511 is different from the lens optical system 25 in that an optical element 521 is provided instead of the metalens 101 and the optical lens 102, and is configured similarly to the lens optical system 25 except for this point.

Specifically, the lens optical system 511 includes an optical element 521 and a band pass filter 103 in order from the incident side of light (left side in FIG. 48).

The aperture stop 531 and the metasurface 532 having positive or negative refractive power are arranged on the optical surface 521a on the incident side of light of the optical element 521. Specifically, the metasurface 532 is formed in the opening of the aperture stop 531. The aperture stop 531 limits light incident on the optical element 521 from a subject. Note that, in the example of FIG. 48, the aperture stop 531 is arranged on the optical surface 521a, but may be separated from the optical element 521.

The metasurface 533 having positive refractive power is arranged on an optical surface 521b on the emission side of light of the optical element 521. Therefore, the aperture stop 531 is arranged on the incident side of light with respect to the metasurface 533 having positive refractive power. The metasurface 532 and the metasurface 533 have a structure similar to the metasurface 112.

The light from the subject is limited by the aperture stop 531 and is incident on the metasurface 532. The light incident on the metasurface 532 is emitted via the metasurface 533, the optical surface 103a, and the optical surface 103b. The light emitted from the lens optical system 511 in this manner is condensed on the light receiving surface 31a via the glass substrate 23, the adhesive 22, and the on-chip lens 32.

As described above, the lens optical system 511 realizes a wide-angle lens optical system by the optical element 521 in which the two metasurfaces 532 and 533 are arranged. Therefore, the size can be reduced as compared with a case where the wide-angle lens optical system is realized only by the optical lens.

Since the optical element 521 includes the two metasurfaces 532 and 533, the metasurface 532 assists the correction of the spherical aberration, so that the metasurface 533 having the positive refractive power can easily correct the aberration of the off-axis light flux. As a result, optical performance can be improved. In the lens optical system 511, since the composite focal length of the metasurfaces 532 and 533 can be shortened as compared with the optical system 25, the lens optical system 511 can be downsized as compared with the lens optical system 25.

### <Specification Example of Lens Optical System>

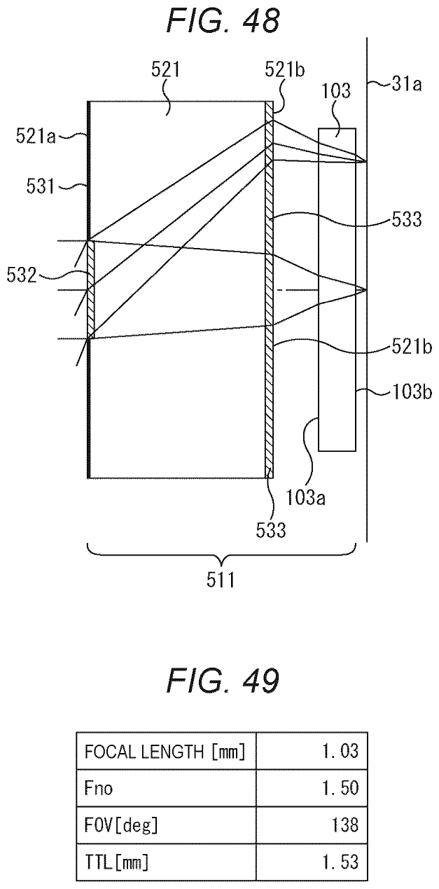

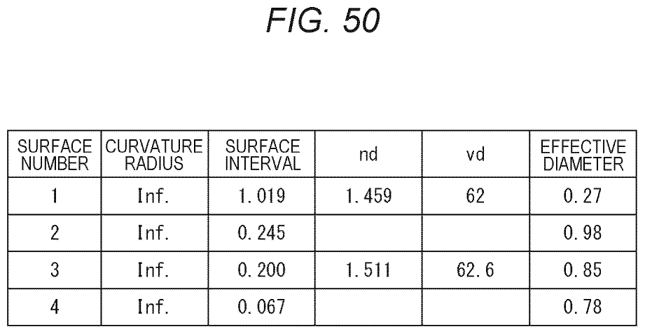

FIG. 49 is a diagram showing a specification example of the lens optical system 511 in FIG. 48.

In the specifications of FIG. 49, the focal length is 1.03 mm, the F-number is 1.50, the FOV is 138 degrees, and the total length TTL of the lens optical system 511 is 1.53. Therefore, 1/(Fno×TTL) is about 0.436.

### <Characteristic Examples of Each Optical Surface>

Next, examples of features of each optical surface of the lens optical system 511 designed on the basis of the specifications of FIG. 49 will be described with reference to FIGS. 50 to 53.

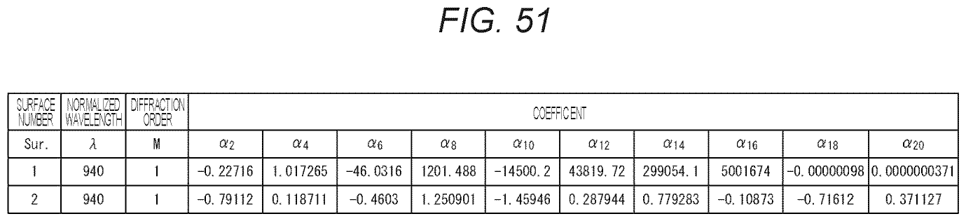

In FIGS. 50 and 51, surface numbers 1 to 4 are sequentially assigned to the optical surfaces 521a, 521b, 103a, and 103b.

The table of FIG. 50 shows the curvature radius, the surface interval, the refractive index nd, the Abbe number vd, and the effective diameter of the optical surface 521a, 521b, 103a, or 103b corresponding to each surface number in association with each surface number.

As shown in FIG. 50, the curvature radius of the optical surface 521a with the surface number “1” is infinite, the surface interval with the optical surface 521b is 1.019 mm, the refractive index nd is 1.459, vd is 62, and the effective diameter is 0.27 mm. The curvature radius of the optical surface 521b with the surface number “2” is infinite, the surface interval with the optical surface 103a is 0.245 mm, and the effective diameter is 0.98 mm.

The curvature radius of the optical surface 103a with the surface number “3” is infinite, the surface interval with the optical surface 103b is 0.200 mm, the refractive index nd is 1.511, vd is 62.6, and the effective diameter is 0.85 mm. The curvature radius of the optical surface 103b with the surface number “4” is infinite, and the effective diameter is 0.78 mm.

The table of FIG. 51 shows the normalized wavelength λ, the diffraction order M, and the coefficient α₂ᵢ in Formula (2) described above as the phase profile of the metasurface 532 or 533 arranged on the optical surfaces 521a or 521b in association with the surface numbers of the optical surfaces 521a and 521b.

As shown in FIG. 51, the normalized wavelength λ of the metasurface 532 arranged on the optical surface 521a with the surface number “1” is 940, and the diffraction order M is 1. The coefficients α₂, α₄, α₆, α₈, α₁₀, α₁₂, α₁₄, α₁₆, α₁₈, and α₂₀ are −0.22716, 1.017265, −46.0316, 1201.488, −14500.2, 43819.72, 299054.1, 5001674, −0.00000098, 0.0000000371, respectively.

The normalized wavelength λ of the metasurface 533 arranged on the optical surface 521b with the surface number “2” is 940, the diffraction order M is 1, and the coefficients α₂, α₄, α₆, α₈, α₁₀, α₁₂, α₁₄, α₁₆, α₁₈, and α₂₀ are −0.79112, 0.118711, −0.4603, 1.250901, −1.45946, 0.287944, 0.779283, −0.10873, −0.71612, and 0.371127, respectively.

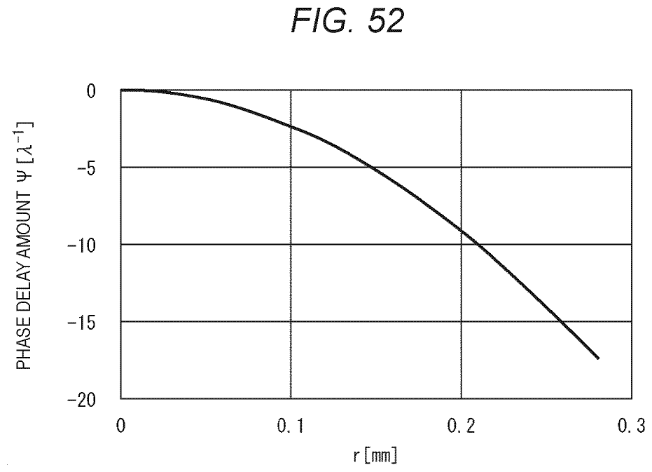

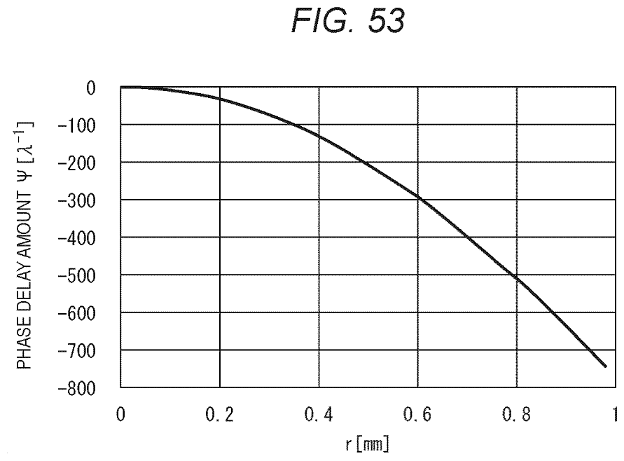

The graph of FIG. 52 shows a profile of the metasurface 532, and the graph of FIG. 53 shows a profile of the metasurface 533.

As shown in FIG. 52, in the metasurface 532, when the distance r from the optical axis is in a range from 0 mm to around 0.3 mm, the phase delay amount w changes from 0 to around −20 such that the phase delay amount ψ increases in the negative direction as the distance r increases.

As shown in FIG. 53, in the metasurface 533, when the distance r from the optical axis is in a range from 0 mm to about 1 mm, the phase delay amount ψ changes from 0 to about −750 such that the phase delay amount ψ increases in the negative direction as the distance r increases.

### <Examples of Spherical Aberration, Field Curvature, and Distortion Aberration>

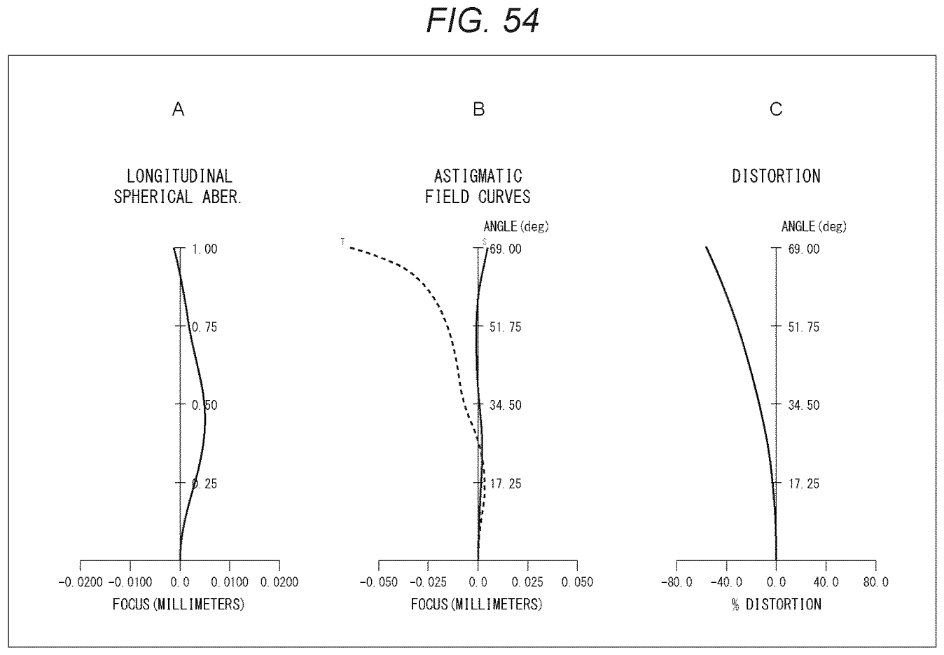

FIG. 54 is a diagram showing an example of spherical aberration, field curvature, and distortion aberration generated in the lens optical system 511 having the features of FIGS. 50 to 53.

A of FIG. 54 is a graph showing the spherical aberration in the longitudinal direction generated in the lens optical system 511 having the features of FIGS. 50 to 53, similarly to A of FIG. 13. B of FIG. 54 is a graph showing the field curvature generated in the lens optical system 511 having the features of FIGS. 50 to 53, similarly to B of FIG. 13. C of FIG. 54 is a graph showing distortion aberration generated in the lens optical system 511 having the features of FIGS. 50 to 53, similarly to C of FIG. 13.

Note that, although illustration is omitted, also in the fifth embodiment, similarly to the first embodiment, in a case where the FOV is 100 degrees or more, spherical aberration and field curvature of the lens optical system 511 can be further reduced, and optical performance can be further improved. Therefore, the FOV is desirably 100 degrees or more.

### <Imaging Apparatus Including Only One Metalens as Lens>

### <Configuration Example of Lens Optical System>

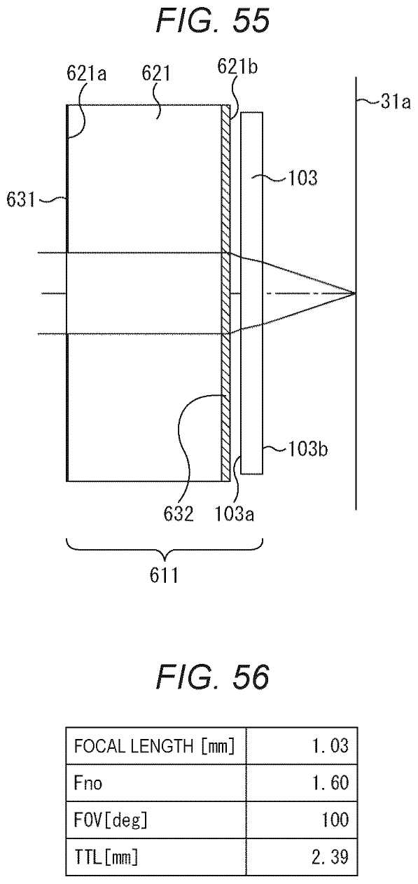

FIG. 55 is a side view showing a configuration example of a lens optical system of an imaging apparatus in which a lens optical system including only one metalens as a lens is provided instead of the lens optical system 25.

In a lens optical system 611 of FIG. 55, portions corresponding to those of the lens optical system 25 of FIG. 4 are denoted by the same reference numerals. Therefore, description of the portion will be appropriately omitted, and description will be given focusing on a portion different from the lens optical system 25. The lens optical system 611 is different from the lens optical system 25 in that a metalens 621 is provided instead of the metalens 101 and the optical lens 102, and is configured similarly to the lens optical system 25 except for this point.

Specifically, the lens optical system 611 includes the metalens 621 and a band pass filter 103 in order from an incident side of light (left side in FIG. 55).

The metalens 621 is an optical element having positive refractive power in the vicinity of the optical axis. An aperture stop 631 is arranged on an optical surface 621a of the metalens 621 on the incident side of light. The aperture stop 631 restricts light incident on the metalens 621 from a subject. A metasurface 632 is arranged on an optical surface 621b on the emission side of light of the metalens 621.

The light from the subject is limited by the aperture stop 631 and is incident on the metasurface 632. The light incident on the metasurface 632 is emitted via the optical surface 103a and the optical surface 103b. The light emitted from the lens optical system 611 in this manner is condensed on the light receiving surface 31a via the glass substrate 23, the adhesive 22, and the on-chip lens 32.

### <Specification Example of Lens Optical System>

FIG. 56 is a diagram showing a specification example of the lens optical system 611 in FIG. 55.

In the specifications of FIG. 56, the focal length is 1.03 mm, the F-number is 1.60, the FOV is 100 degrees, and the total length TTL of the lens optical system 611 is 2.39. Therefore, 1/(Fno×TTL) is about 0.262.

### <Characteristic Examples of Each Optical Surface>

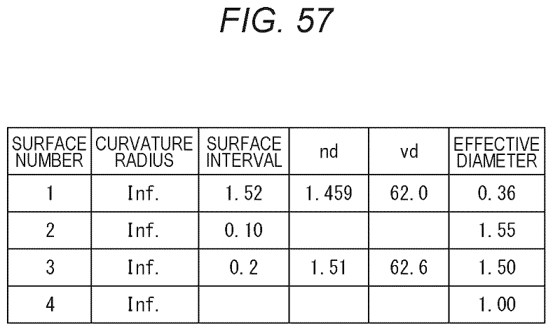

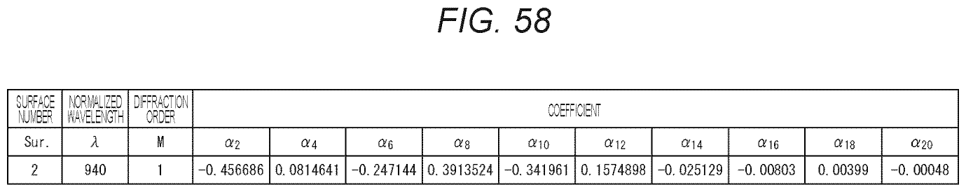

Next, examples of features of each optical surface of the lens optical system 611 designed on the basis of the specifications of FIG. 56 will be described with reference to FIGS. 57 to 59.

In FIGS. 57 and 58, surface numbers 1 to 4 are sequentially assigned to the optical surfaces 621a, 621b, 103a, and 103b.

The table of FIG. 57 shows the curvature radius, the surface interval, the refractive index nd, the Abbe number vd, and the effective diameter of the optical surface 621a, 621b, 103a, or 103b corresponding to each surface number in association with each surface number.

As shown in FIG. 57, the curvature radius of the optical surface 621a with the surface number “1” is infinite, the surface interval with the optical surface 621b is 1.52 mm, the refractive index nd is 1.459, vd is 62.0, and the effective diameter is 0.36 mm. Therefore, the interval between the aperture stop 631 arranged on the optical surface 621a and the metasurface 632 arranged on the optical surface 621b is 1.52 mm. The curvature radius of the optical surface 621b with the surface number “2” is infinite, the surface interval with the optical surface 103a is 0.10 mm, and the effective diameter is 1.55 mm.

The curvature radius of the optical surface 103a with the surface number “3” is infinite, the surface interval with the optical surface 103b is 0.2 mm, the refractive index nd is 1.51, vd is 62.6, and the effective diameter is 1.50 mm. The curvature radius of the optical surface 103b with the surface number “4” is infinite, and the effective diameter is 1.00 mm.

The table of FIG. 58 shows the normalized wavelength λ, the diffraction order M, and the coefficient α₂ᵢ in Formula (2) described above as the phase profile of the metasurface 632 arranged on the optical surface 621b.

As shown in FIG. 58, the normalized wavelength λ of the metasurface 632 arranged on the optical surface 621b with the surface number “2” is 940, and the diffraction order M is 1. The coefficients α₂, α₄, α₆, α₈, α₁₀, α₁₂, α₁₄, α₁₆, α₁₈, and α₂₀ are −0.456686, 0.0814641, −0.247144, 0.3913524, −0.341961, 0.1574898, −0.025129, −0.00803, 0.00399, and −0.00048, respectively.

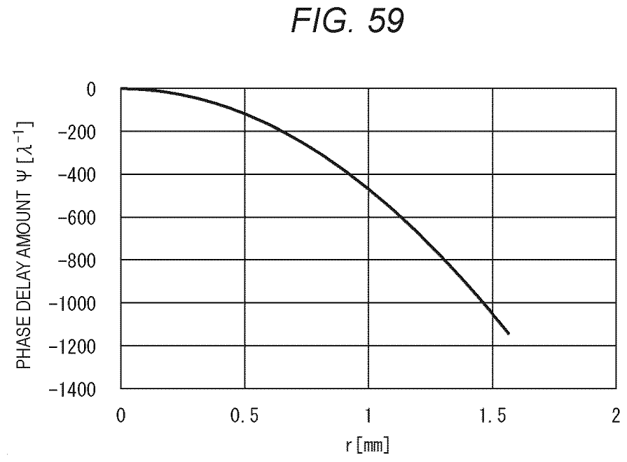

The graph of FIG. 59 shows a profile of the metasurface 632.

As shown in FIG. 59, when the distance r from the optical axis is in a range from 0 mm to around 1.5 mm, the phase delay amount ψ changes from 0 to around −1200 such that the phase delay amount ψ increases in the negative direction as the distance r increases.

### <Examples of Spherical Aberration, Field Curvature, and Distortion Aberration>

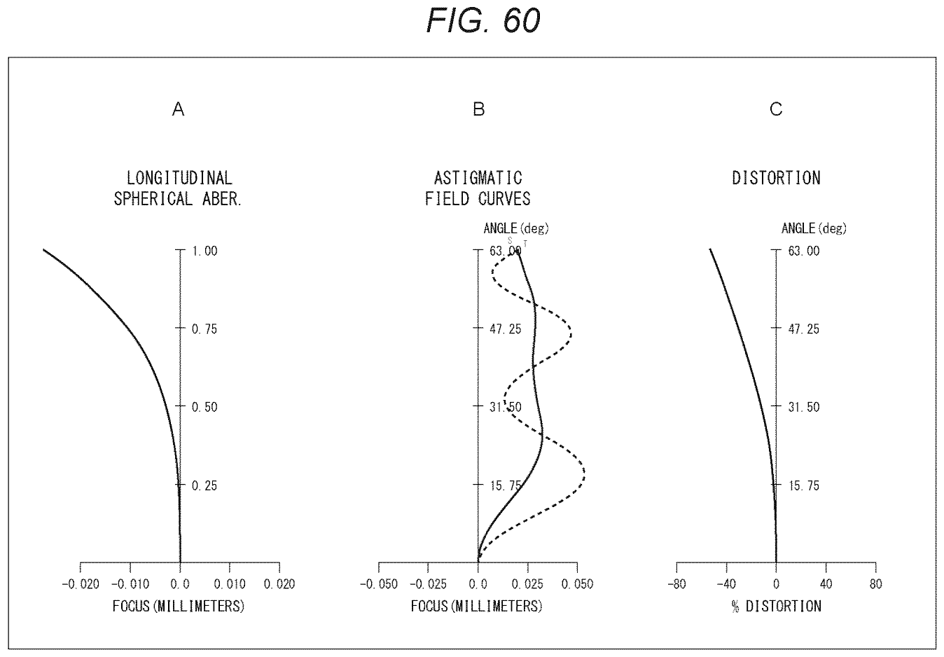

FIG. 60 is a diagram showing an example of spherical aberration, field curvature, and distortion aberration generated in the lens optical system 611 having the features of FIGS. 57 to 59.

A of FIG. 60 is a graph showing the spherical aberration in the longitudinal direction generated in the lens optical system 611 having the features of FIGS. 57 to 59, similarly to A of FIG. 13. B of FIG. 60 is a graph showing the field curvature generated in the lens optical system 611 having the features of FIGS. 57 to 59, similarly to B of FIG. 13. C of FIG. 60 is a graph showing distortion aberration generated in the lens optical system 611 having the features of FIGS. 57 to 59, similarly to C of FIG. 13.

### <Imaging Apparatus Including Only Four Optical Lenses as Lenses>

### <Configuration Example of Lens Optical System>

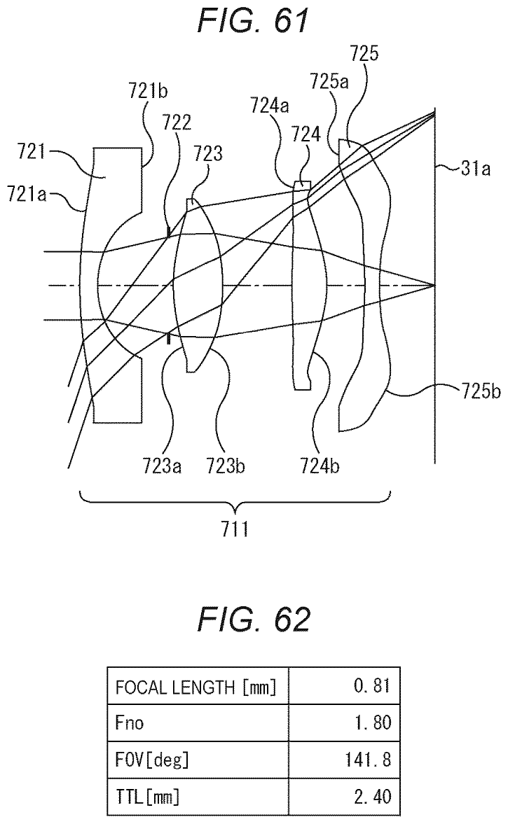

FIG. 61 is a side view showing a configuration example of a lens optical system of an imaging apparatus in which a lens optical system including only four optical lenses as lenses is provided instead of the lens optical system 25.

A lens optical system 711 includes an optical lens 721, an aperture stop 722, an optical lens 723, an optical lens 724, and an optical lens 725 in order from an incident side of light (left side in FIG. 61). The aperture stop 722 limits light incident on the optical lens 721 from the optical lens 723.

The light from the subject is incident on an optical surface 721a on the incident side of light of the optical lens 721, and is emitted to the aperture stop 722 via an optical surface 721b on the emission side. The light incident on the aperture stop 423 and limited is incident on an optical surface 723a on the incident side of light of the optical lens 723 and is emitted from an optical surface 723b on the light emission side. The light emitted from the optical surface 723b is incident on an optical surface 724a on the incident side of light of the optical lens 724, and is emitted from an optical surface 724b on the emission side. The light emitted from the optical surface 724b is incident on an optical surface 725a on the incident side of light of the optical lens 725, and is emitted from an optical surface 725b on the emission side. The light emitted from the lens optical system 711 in this manner is condensed on the light receiving surface 31a via the glass substrate 23, the adhesive 22, and the on-chip lens 32.

### <Specification Example of Lens Optical System>

FIG. 62 is a diagram showing a specification example of the lens optical system 711 in FIG. 61.

In the specifications of FIG. 62, the focal length is 0.81 mm, the F-number is 1.80, the FOV is 141.8 degrees, and the total length TTL of the lens optical system 711 is 2.40. Therefore, 1/(Fno×TTL) is about 0.231.

### <Characteristic Examples of Each Optical Surface>

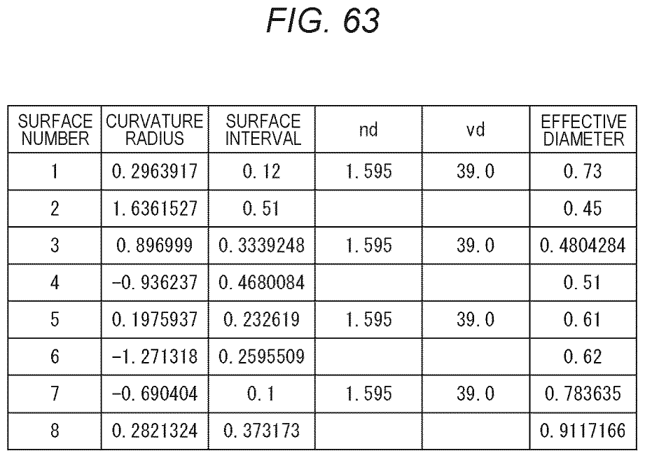

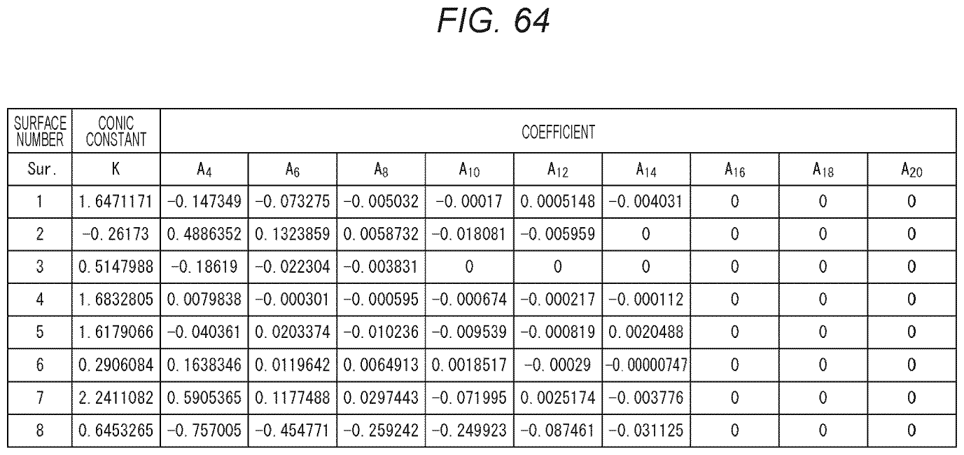

Next, examples of features of each optical surface of the lens optical system 711 designed on the basis of the specifications of FIG. 62 will be described with reference to FIGS. 63 to 64.

In FIGS. 63 and 64, surface numbers 1 to 8 are sequentially assigned to the optical surfaces 721a, 721b, 723a, 723b, 724a, 724b, 725a, and 725b.

The table of FIG. 63 shows the curvature radius, the surface interval, the refractive index nd, the Abbe number vd, and the effective diameter of the optical surfaces 721a, 721b, 723a, 723b, 724a, 724b, 725a, or 725b corresponding to each surface number in association with each surface number.

As shown in FIG. 63, the curvature radius of the optical surface 721a with the surface number “1” is 0.2963917, the surface interval with the optical surface 721b is 0.12 mm, the refractive index nd is 1.595, vd is 39.0, and the effective diameter is 0.73 mm. The curvature radius of the optical surface 721b with the surface number “2” is 1.6361527, the surface interval with the optical surface 723a is 0.51 mm, and the effective diameter is 0.45 mm.

The curvature radius of the optical surface 723a with the surface number “3” is 0.896999, the surface interval with the optical surface 723b is 0.3339248 mm, the refractive index nd is 1.595, vd is 39.0, and the effective diameter is 0.4804284 mm. The curvature radius of the optical surface 723b with the surface number “4” is −0.936237, the surface interval with the optical surface 724a is 0.4680084 mm, and the effective diameter is 0.51 mm.

The curvature radius of the optical surface 724a with the surface number “5” is 0.1975937, the surface interval with the optical surface 724b is 0.232619 mm, the refractive index nd is 1.595, vd is 39.0, and the effective diameter is 0.61 mm. The curvature radius of the optical surface 724b with the surface number “6” is −1.271618, the surface interval with the optical surface 725a is 0.2595509 mm, and the effective diameter is 0.62 mm.

The curvature radius of the optical surface 725a with the surface number “7” is −0.690404, the surface interval with the optical surface 725b is 0.1 mm, the refractive index nd is 1.595, vd is 39.0, and the effective diameter is 0.783635 mm. The curvature radius of the optical surface 725b with the surface number “8” is 0.2821324, and the effective diameter is 0.9117166 mm.

The table of FIG. 64 shows the conic constant K and the coefficient A₂ᵢ in Formula (1) described above as the profile of the aspherical shape of the optical surface 721a, 721b, 723a, 723b, 724a, 724b, 725a, or 725b corresponding to each surface number in association with each surface number.

As shown in FIG. 64, the conic constant K of the optical surface 721a with the surface number “1” is 1.6471171. The coefficients A₄, A₆, As, A₁₀, A₁₂, and A₁₄ are −0.147349, −0.073275, −0.005032, −0.00017, 0.0005148, and −0.004031, respectively. A₁₆, A₁₈, and A₂₀ are all 0.

The conic constant K of the optical surface 721b with the surface number “2” is −0.26173. The coefficients A₄, A₆, A₈, A₁₀, and A₁₂ are 0.4886352, 0.1323859, 0.0058732, −0.018081, and −0.005959, respectively. The coefficients A₁₄, A₁₆, A₁₈, and A₂₀ are all 0.

The conic constant K of the optical surface 723a with the surface number “3” is 0.5147988. The coefficients A₄, A₆, A₈, A₁₀, and A₁₂ are −0.18619, −0.022304, and −0.003831, respectively. A₁₀, A₁₂, A₁₄, A₁₆, A₁₈, and A₂₀ are all 0.

The conic constant K of the optical surface 723b with the surface number “4” is 1.6832805. The coefficients A₄, A₆, A₈, A₁₀, A₁₂, and A₁₄ are 0.0079838, −0.000301, −0.000595, −0.000674, −0.000217, and −0.000112, respectively. A₁₆, A₁₈, and A₂₀ are all 0.

The conic constant K of the optical surface 724a with the surface number “5” is 1.6179066. The coefficients A₄, A₆, As, A₁₀, A₁₂, and A₁₄ are −0.040361, 0.0203374, −0.010236, −0.009539, −0.000819, and 0.0020488, respectively. A₁₆, A₁₈, and A₂₀ are all 0.

The conic constant K of the optical surface 724b with the surface number “6” is 0.2906084. The coefficients A₄, A₆, A₈, A₁₀, A₁₂, and A₁₄ are 0.1638346, 0.0119642, 0.0064913, 0.0018517, −0.00029, and −0.00000747, respectively. A₁₆, A₁₈, and A₂₀ are all 0.

The conic constant K of the optical surface 725a with the surface number “7” is 2.2411082. The coefficients A₄, A₆, As, A₁₀, A₁₂, and A₁₄ are 0.5905365, 0.1177488, 0.0297443, −0.071995, 0.0025174, and −0.003776, respectively. A₁₆, A₁₈, and A₂₀ are all 0.

The conic constant K of the optical surface 725b with the surface number “8” is 0.6453265. The coefficients A₄, A₆, A₈, A₁₀, A₁₂, and A₁₄ are −0.757005, −0.454771, and −0.259242, respectively, and the coefficient A₁₀ is −0.249923, −0.087461, and −0.031125, respectively. A₁₆, A₁₈, and A₂₀ are all 0.

### <Examples of Spherical Aberration, Field Curvature, and Distortion Aberration>

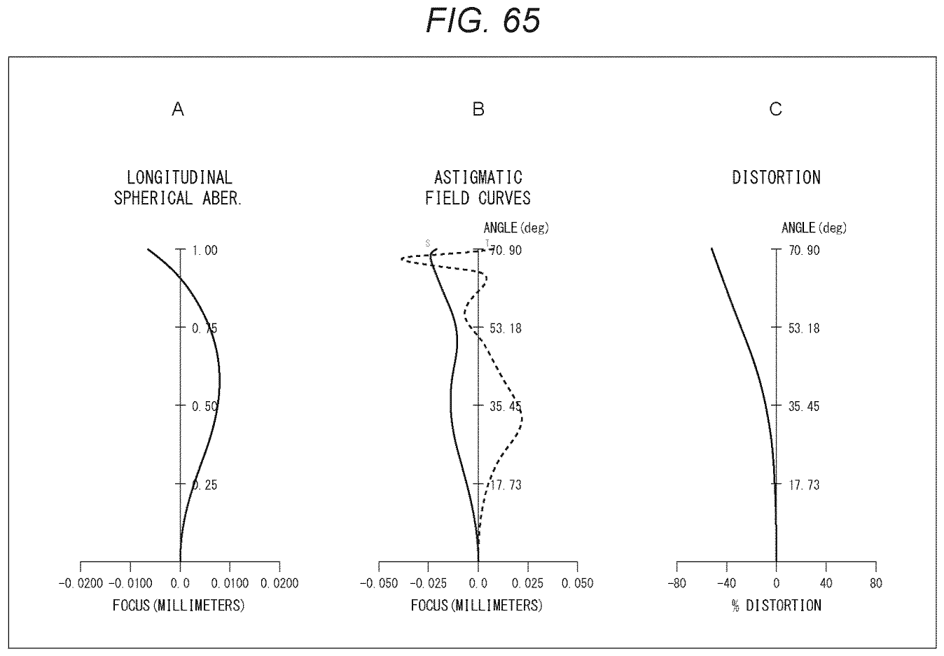

FIG. 65 is a diagram showing an example of spherical aberration, field curvature, and distortion aberration generated in the lens optical system 711 having the features of FIGS. 63 to 64.

A of FIG. 65 is a graph showing the spherical aberration in the longitudinal direction generated in the lens optical system 711 having the features of FIGS. 63 to 64, similarly to A of FIG. 13. B of FIG. 65 is a graph showing the field curvature generated in the lens optical system 711 having the features of FIGS. 63 to 64, similarly to B of FIG. 13. C of FIG. 65 is a graph showing distortion aberration generated in the lens optical system 711 having the features of FIGS. 63 to 64, similarly to C of FIG. 13.

As described above, as shown in FIGS. 13, 19, 33, 40, 47, and 54, the spherical aberration, the field curvature, and the distortion aberration in a case where 1/(Fno×TTL) is 0.25 or more are better than the spherical aberration, the field curvature, and the distortion aberration shown in FIGS. 60 and 65. However, as shown in FIG. 25, the spherical aberration, the field curvature, and the distortion aberration in the case where 1/(Fno×TTL) is 0.25 or less are equal to or defective compared with the spherical aberration, the field curvature, and the distortion aberration shown in FIGS. 60 and 65. Furthermore, in a case where 1/(Fno×TTL) is larger than 0.45, it is difficult to correct field curvature and coma aberration of off-axis light flux. Therefore, in the first to fifth embodiments, for example, the following conditions are desirably satisfied.

$$[ Math . 3 ]$$

$$0. 25 \leq \frac{1}{FNO \times TTL} \leq 0.45$$

### <Application Example to Electronic Apparatus

The imaging apparatus including the lens optical system 25 (211,311,411,511) described above can be applied to various electronic apparatuses such as a digital still camera, a digital video camera, a mobile phone having an imaging function, or another apparatus having an imaging function, for example.

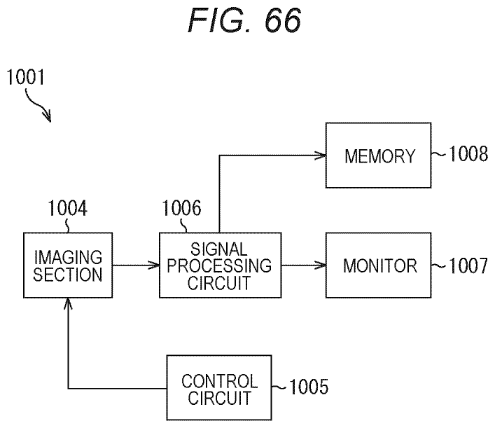

FIG. 66 is a block diagram showing a configuration example of a digital still camera as an electronic apparatus to which the present technology is applied.

A digital still camera 1001 shown in FIG. 66 includes an imaging section 1004, a control circuit 1005, a signal processing circuit 1006, a monitor 1007, and a memory 1008, and can capture a still image and a moving image.

The imaging section 1004 includes an imaging apparatus or the like including the lens optical system 25 (211,311,411,511) described above. The imaging section 1004 forms an image of light from a subject on a light receiving surface, and accumulates signal charges for a certain period of time according to the received light. The signal charge accumulated in the imaging section 1004 is transferred in accordance with a drive signal (timing signal) supplied from the control circuit 1005.

The control circuit 1005 outputs a drive signal for controlling the transfer operation of the imaging section 1004 to drive the imaging section 1004.

The signal processing circuit 1006 performs various types of signal processing on the signal charge output from the imaging section 1004. The image (image data) obtained by the signal processing applied by the signal processing circuit 1006 is supplied to the monitor 1007 to be displayed or supplied to the memory 1008 to be stored (recorded).

Also in the digital still camera 1001 configured as described above, optical performance can be improved by applying the lens optical system 25 (211,311,411,511) as the lens optical system of the imaging section 1004. Therefore, the image quality of the captured image can be improved.

### <Usage Example of Imaging Apparatus>

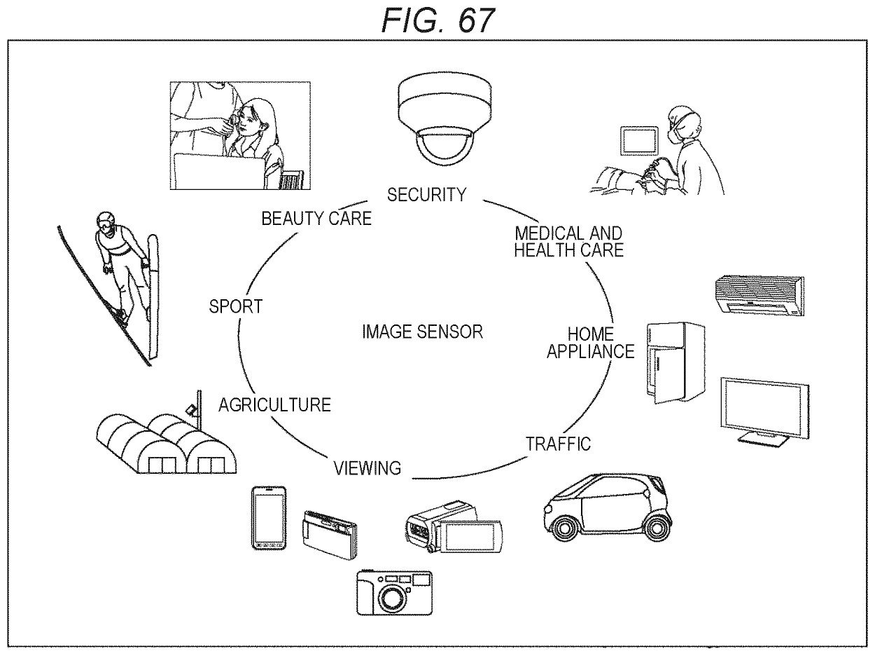

FIG. 67 is a diagram showing a usage example of using an imaging apparatus including the lens optical system 25 (211,311,411,511) described above.

The imaging apparatus including the lens optical system 25 (211,311,411,511) described above can be used, for example, in various cases of sensing light such as visible light, infrared light, ultraviolet light, and X-rays as follows.
A device that captures an image, provided for viewing purposes, such as a digital camera and a portable device with a camera function
An apparatus for traffic purpose such as an in-vehicle sensor that captures images of the front, rear, surroundings, interior, and the like of an automobile, a monitoring camera for monitoring traveling vehicles and roads, and a ranging sensor that measures a distance between vehicles and the like for safe driving such as automatic stop, recognition of a driver's condition, and the like
A device provided for home appliance such as a television, a refrigerator, and an air conditioner that captures an image of a user's gesture and performs a device operation according to the gesture
A device provided for medical and health care such as an endoscope and a device that performs angiography by receiving infrared light
An apparatus provided for security such as a security monitoring camera and an individual authentication camera
An apparatus provided for beauty care such as a skin measuring instrument for capturing images of skin and a microscope for capturing images of the scalp
An apparatus provided for sport such as an action camera or a wearable camera for sports applications or the like
An apparatus provided for agricultural purposes, such as a camera for monitoring conditions of fields and crops.

### <Application Example to Endoscopic Surgery System>

The technology according to the present disclosure (the present technology) can be applied to various products. For example, the technology according to the present disclosure may be applied to an endoscopic surgery system.

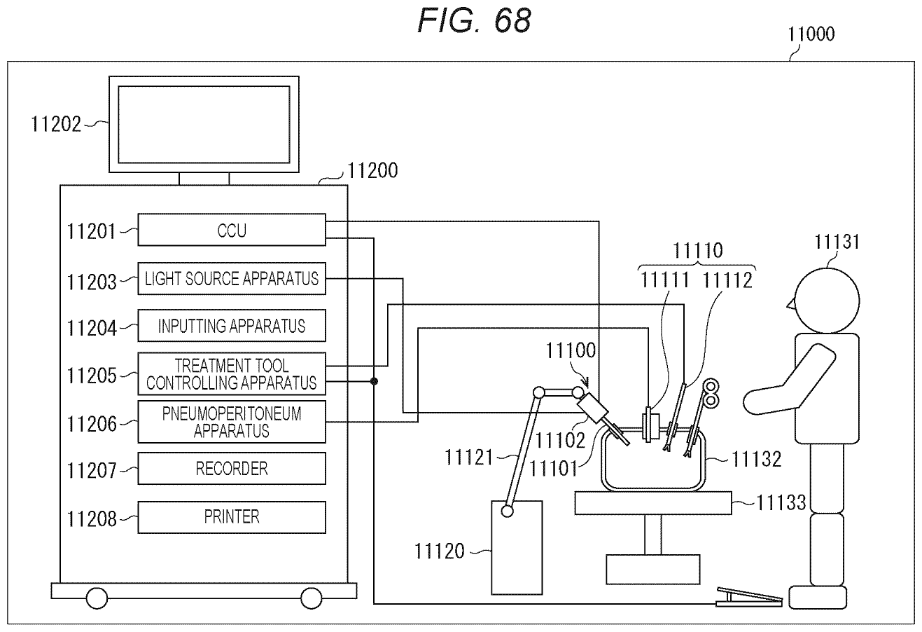

FIG. 68 is a diagram showing an example of a schematic configuration of an endoscopic surgery system to which the technology according to the present disclosure (the present technology) can be applied.

FIG. 68 shows a state where an operator (doctor) 11131 performs surgery on a patient 11132 on a patient bed 11133, by using an endoscopic surgery system 11000. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example depicted, the endoscope 11100 is depicted which includes as a rigid endoscope having the lens barrel 11101 of the hard type. However, the endoscope 11100 may otherwise be included as a flexible endoscope having the lens barrel 11101 of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 is formed with a light source such as a light emitting diode (LED), for example, and supplies irradiation light for imaging a surgical region or the like to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

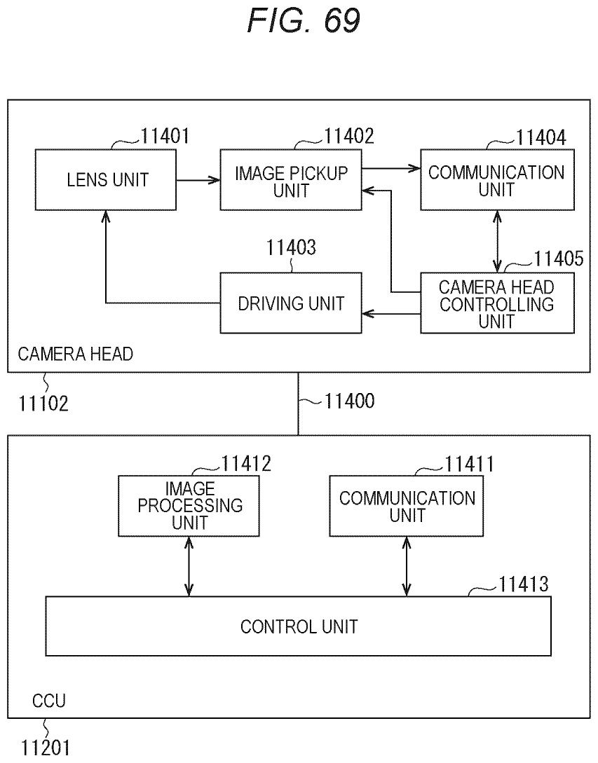

FIG. 69 is a block diagram showing an example of a functional configuration of the camera head 11102 and the CCU 11201 depicted in FIG. 68.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The image pickup unit 11402 includes an image pickup element. The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. Alternatively, the image pickup unit 11402 may include a pair of image pickup elements for acquiring right-eye and left-eye image signals compatible with three-dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

An example of the endoscopic surgery system to which the technology according to the present disclosure can be applied has been described above. The technology according to the present disclosure can be applied to the lens unit 11401, the image pickup unit 11402, and the like among the above-described configurations. Specifically, the imaging apparatus including the lens optical system 25 (211,311,411,511) described above can be applied to the lens unit 11401 and the image pickup unit 11402. By applying the technology according to the present disclosure to the lens unit 11401 and the image pickup unit 11402, optical characteristics can be improved. As a result, a clearer image of the surgical site can be obtained, and thus, for example, the operator can reliably confirm the surgical region.

Note that an endoscopic surgery system has been described as an example herein, but in addition, the technology according to the present disclosure may be applied to a microscopic surgery system or the like, for example.

### <Application Example to Mobile Body>

The technology according to the present disclosure (the present technology) can be applied to various products. For example, the technology according to the present disclosure may be implemented in the form of a device to be mounted on a mobile body of any kind, such as an automobile, an electric vehicle, a hybrid electric vehicle, a motorcycle, a bicycle, a personal mobility, an airplane, a drone, a vessel, or a robot.

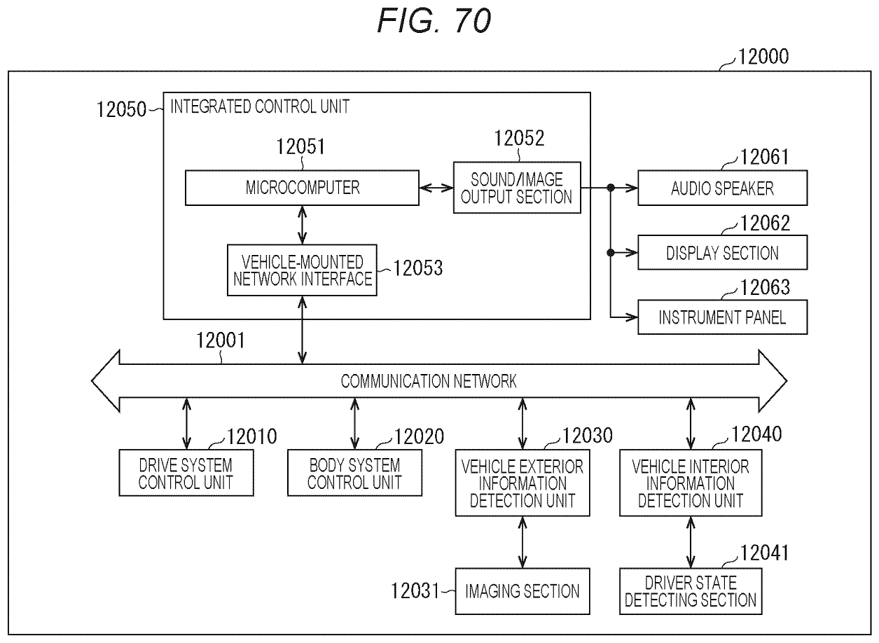

FIG. 70 is a block diagram showing a schematic configuration example of a vehicle control system that is an example of a mobile body control system to which the technology according to the present disclosure can be applied.

The vehicle control system 12000 includes a plurality of electronic control units connected to each other via a communication network 12001. In the example shown in FIG. 70, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are shown as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020, on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 70, an audio speaker 12061, a display section 12062, and an instrument panel 12063 are shown as the output device. The display section 12062 may, for example, include at least one of an on-board display and a head-up display.

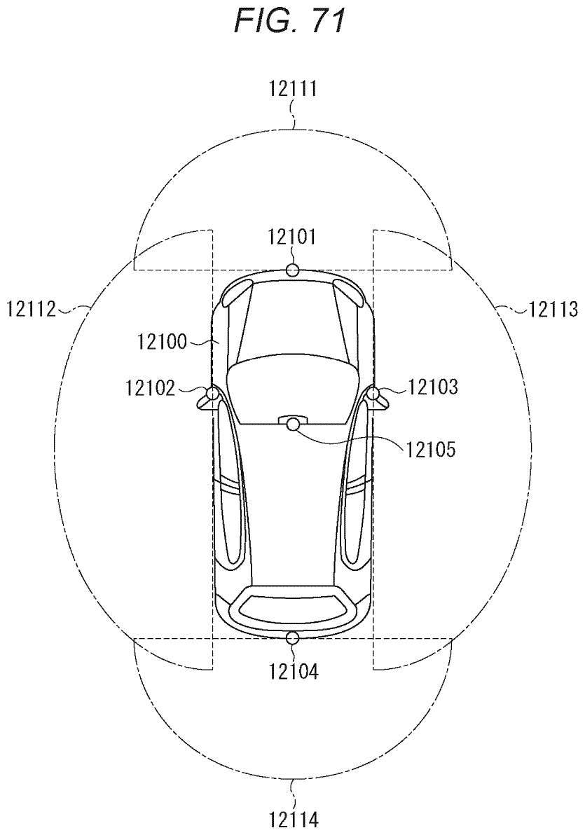

FIG. 71 is a diagram showing an example of an installation position of the imaging section 12031.

In FIG. 71, the vehicle 12100 includes imaging sections 12101,12102, 12103, 12104, and 12105 as the imaging section 12031.

The imaging sections 12101, 12102, 12103, 12104, 12105 are provided, for example, at positions such as a front nose, a sideview mirror, a rear bumper, a back door, and an upper portion of a windshield in the interior of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. Images of the front to be obtained by the imaging sections 12101 and 12105 are used mainly to detect a preceding vehicle, a pedestrian, an obstacle, a traffic signal, a traffic sign, a lane, or the like.

Note that FIG. 71 shows an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 and the like in the configuration described above. Specifically, the imaging apparatus including the lens optical system 25 (211,311,411,511) described above can be applied to the imaging section 12031. By applying the technology according to the present disclosure to the imaging section 12031, optical characteristics can be improved. As a result, a more easily viewable captured image can be obtained, and thus, for example, driver's fatigue can be reduced.

An embodiment of the present technology is not limited to the embodiments described above, and various modifications can be made without departing from the scope of the present technology.

For example, it is possible to employ a mode obtained by combining all or some of the plurality of embodiments described above.

Note that the effects described in the present specification are merely examples and are not restrictive, and there may be effects other than those described in the present specification.

The present technology can have the following configurations.

(1)

A lens optical system including, in order from an incident side of light:
a first lens having positive refractive power; and
a second lens having positive refractive power, in which
a metasurface including a plurality of nanostructures is arranged in the first lens,
an aperture stop is arranged on the incident side of the metasurface, and
at least one optical surface of the second lens has an aspherical shape.

(2)

The lens optical system according to (1), in which
the metasurface is arranged on an optical surface of the first lens on an emission side of light.

(3)

The lens optical system according to (1), in which
the aspherical shape has an inflection point.

(4)

The lens optical system according to any one of (1) to (3), in which
an interval between the aperture stop and the metasurface is larger than 0.6 mm.

(5)

The lens optical system according to any one of (1) to (4), in which
an angle of view is 100 degrees or more.

(6)

The lens optical system according to any one of (1) to (5), in which
when an F value is FNO and a total length of the lens optical system is TTL [mm], a condition of

$$[ Mathematical formula 3 ]$$

$$0.25 \leq \frac{1}{FNO \times TTL} \leq 0.45$$

is satisfied.

(7)

An imaging apparatus including:
a lens optical system including, in order from an incident side of light:
a first lens having positive refractive power; and
a second lens having positive refractive power, in which
a metasurface including a plurality of nanostructures is arranged on an optical surface of the first lens on an emission side of light,
an aperture stop is arranged on the incident side of the metasurface, and
at least one optical surface of the second lens has an aspherical shape;
a solid-state imaging element in which light receiving elements are arranged in a two-dimensional lattice pattern; and
a glass substrate arranged between a light receiving surface of the solid-state imaging element and the lens optical system.

(8)

A lens optical system including, in order from an incident side of light:
a first lens having negative refractive power in a vicinity of an optical axis;
a second lens having positive refractive power in a vicinity of the optical axis; and
an optical element having positive refractive power in a vicinity of the optical axis, in which
a first optical surface of the optical element is configured by a flat surface or a curved surface, and
a metasurface including a plurality of nanostructures is arranged on a second optical surface of the optical element.

(9)

The lens optical system according to (8), in which the first optical surface is arranged on the incident side of the second optical surface.

(10)

The lens optical system according to (8) or (9), further including an aperture stop arranged between the first lens and the second lens.

(11)

The lens optical system according to (10), in which
an interval between the aperture stop and the metasurface is larger than 0.6 mm.

(12)

The lens optical system according to any one of (8) to (11), in which
an angle of view is 100 degrees or more.

(13)

The lens optical system according to any one of (8) to (12), in which
when an F value is FNO and a total length of the lens optical system is TTL [mm], a condition of

$$[ Mathematical formula 3 ]$$

$$0.25 \leq \frac{1}{FNO \times TTL} \leq 0.45$$

is satisfied.

(14)

An imaging apparatus including:
a lens optical system including, in order from an incident side of light:
a first lens having negative refractive power in a vicinity of an optical axis;
a second lens having positive refractive power in a vicinity of the optical axis; and
an optical element having positive refractive power in a vicinity of the optical axis, in which
a first optical surface of the optical element is configured by a flat surface or a curved surface, and
a metasurface including a plurality of nanostructures is arranged on a second optical surface of the optical element;
a solid-state imaging element in which light receiving elements are arranged in a two-dimensional lattice pattern; and
a glass substrate arranged between a light receiving surface of the solid-state imaging element and the lens optical system.

(15)

A lens optical system including, in order from an incident side of light:
a first lens;
a second lens;
an optical element having positive refractive power in a vicinity of an optical axis; and
a third lens, in which
a first optical surface of the optical element is configured by a flat surface or a curved surface,
a metasurface including a plurality of nanostructures is arranged on a second optical surface of the optical element,
the metasurface has positive refractive power, and
in a case where the first optical surface is arranged on the incident side with respect to the second optical surface, the second lens has positive refractive power in a vicinity of the optical axis, and in a case where the second optical surface is arranged on the incident side with respect to the first optical surface, the third lens has positive refractive power.

(16)

The lens optical system according to (15), further including an aperture stop arranged between the first lens and the second lens.

(17)

The lens optical system according to (16), in which
an interval between the aperture stop and the metasurface is larger than 0.6 mm.

(18)

The lens optical system according to any one of (15) to (17), in which
an angle of view is 100 degrees or more.

(19)

The lens optical system according to any one of (15) to (18), in which
when an F value is FNO and a total length of the lens optical system is TTL [mm], a condition of

$$[ Mathematical formula 3 ]$$

$$0.25 \leq \frac{1}{FNO \times TTL} \leq 0.45$$

is satisfied.

(20)

An imaging apparatus including:
a lens optical system including, in order from an incident side of light:
a first lens;
a second lens;
an optical element having positive refractive power in a vicinity of an optical axis; and
a third lens, in which
a first optical surface of the optical element is configured by a flat surface or a curved surface,
a metasurface including a plurality of nanostructures is arranged on a second optical surface of the optical element,
the metasurface has positive refractive power, and
in a case where the first optical surface is arranged on the incident side with respect to the second optical surface, the second lens has positive refractive power in a vicinity of the optical axis, and in a case where the second optical surface is arranged on the incident side with respect to the first optical surface, the third lens has positive refractive power;
a solid-state imaging element in which light receiving elements are arranged in a two-dimensional lattice pattern; and
a glass substrate arranged between a light receiving surface of the solid-state imaging element and the lens optical system.

(21)

A lens optical system including:
two metasurfaces at least one of which has positive refractive power; and
an aperture stop arranged on an incident side of light of the metasurfaces having positive refractive power.

(22)

An imaging apparatus including:
a lens optical system including:
two metasurfaces at least one of which has positive refractive power; and
an aperture stop arranged on an incident side of light of the metasurface having positive refractive power;
a solid-state imaging element in which light receiving elements are arranged in a two-dimensional lattice pattern; and
a glass substrate arranged between a light receiving surface of the solid-state imaging element and the lens optical system.

### REFERENCE SIGNS LIST

10 Imaging apparatus
21 Solid-state imaging element
23 Glass substrate
25 Lens optical system
101 Metalens
101b Optical surface
102 Optical lens
102a, 102b Optical surface
111 Aperture stop
112 Metasurface
132 Nanostructure
211 Lens optical system
221 Optical lens
222 Aperture stop
223 Optical lens
224 Optical element
224a, 224b Optical surface
231 Metasurface
311 Lens optical system
321 Optical lens
322 Aperture stop
323 Optical lens
324 Optical element
324a, 324b Optical surface
325 Optical lens
331 Metasurface
411 Lens optical system
421, 422 Optical lens
424 Optical element
424a, 424b Optical surface
425 Optical lens
431 Metasurface
511 Lens optical system
521 Optical element
531 Aperture stop
532, 533 Metasurface

What is claimed is:

1. A lens optical system comprising, in order from an incident side of light:
a first lens having positive refractive power; and
a second lens having positive refractive power, wherein
a metasurface including a plurality of nanostructures is arranged in the first lens,
an aperture stop is arranged on the incident side of the metasurface, and
at least one optical surface of the second lens has an aspherical shape.

2. The lens optical system according to claim 1, wherein
the metasurface is arranged on an optical surface of the first lens on an emission side of light.

3. The lens optical system according to claim 1, wherein
the aspherical shape has an inflection point.

4. The lens optical system according to claim 1, wherein
an interval between the aperture stop and the metasurface is larger than 0.6 mm.

5. The lens optical system according to claim 1, wherein
an angle of view is 100 degrees or more.

6. The lens optical system according to claim 1, wherein
when an F value is FNO and a total length of the lens optical system is TTL [mm], a condition of
$$[ Mathematical formula 3 ]$$
$$0.25 \leq \frac{1}{FNO \times TTL} \leq 0.45$$
is satisfied.

7. An imaging apparatus, comprising:
a lens optical system including, in order from an incident side of light:
a first lens having positive refractive power; and
a second lens having positive refractive power, in which
a metasurface including a plurality of nanostructures is arranged in the first lens,
an aperture stop is arranged on the incident side of the metasurface, and
at least one optical surface of the second lens has an aspherical shape;
a solid-state imaging element in which light receiving elements are arranged in a two-dimensional lattice pattern; and
a glass substrate arranged between a light receiving surface of the solid-state imaging element and the lens optical system.

8. A lens optical system comprising, in order from an incident side of light:
a first lens having negative refractive power in a vicinity of an optical axis;
a second lens having positive refractive power in a vicinity of the optical axis; and
an optical element having positive refractive power in a vicinity of the optical axis, wherein
a first optical surface of the optical element is configured by a flat surface or a curved surface, and
a metasurface including a plurality of nanostructures is arranged on a second optical surface of the optical element.

9. The lens optical system according to claim 8, wherein
the first optical surface is arranged on the incident side of the second optical surface.

10. The lens optical system according to claim 8, further comprising an aperture stop arranged between the first lens and the second lens.

11. The lens optical system according to claim 10, wherein
an interval between the aperture stop and the metasurface is larger than 0.6 mm.

12. The lens optical system according to claim 8, wherein
an angle of view is 100 degrees or more.

13. The lens optical system according to claim 8, wherein
when an F value is FNO and a total length of the lens optical system is TTL [mm], a condition of
$$[ Mathematical formula 3 ]$$
$$0.25 \leq \frac{1}{FNO \times TTL} \leq 0.45$$
is satisfied.

14. An imaging apparatus, comprising:
a lens optical system including, in order from an incident side of light:
a first lens having negative refractive power in a vicinity of an optical axis;
a second lens having positive refractive power in a vicinity of the optical axis; and
an optical element having positive refractive power in a vicinity of the optical axis, in which
a first optical surface of the optical element is configured by a flat surface or a curved surface, and
a metasurface including a plurality of nanostructures is arranged on a second optical surface of the optical element;
a solid-state imaging element in which light receiving elements are arranged in a two-dimensional lattice pattern; and
a glass substrate arranged between a light receiving surface of the solid-state imaging element and the lens optical system.

15. A lens optical system comprising, in order from an incident side of light:
a first lens;
a second lens;
an optical element having positive refractive power in a vicinity of an optical axis; and
a third lens, wherein
a first optical surface of the optical element is configured by a flat surface or a curved surface,
a metasurface including a plurality of nanostructures is arranged on a second optical surface of the optical element,
the metasurface has positive refractive power, and
in a case where the first optical surface is arranged on the incident side with respect to the second optical surface, the second lens has positive refractive power in a vicinity of the optical axis, and in a case where the second optical surface is arranged on the incident side with respect to the first optical surface, the third lens has positive refractive power.

16. The lens optical system according to claim 15, further comprising an aperture stop arranged between the first lens and the second lens.

17. The lens optical system according to claim 16, wherein
an interval between the aperture stop and the metasurface is larger than 0.6 mm.

18. The lens optical system according to claim 15, wherein
an angle of view is 100 degrees or more.

19. The lens optical system according to claim 15, wherein
when an F value is FNO and a total length of the lens optical system is TTL [mm], a condition of
$$[ Mathematical formula 3 ]$$
$$0.25 \leq \frac{1}{FNO \times TTL} \leq 0.45$$
is satisfied.

20. An imaging apparatus, comprising:
a lens optical system including, in order from an incident side of light:
a first lens;
a second lens;
an optical element having positive refractive power in a vicinity of an optical axis; and
a third lens, in which
a first optical surface of the optical element is configured by a flat surface or a curved surface,
a metasurface including a plurality of nanostructures is arranged on a second optical surface of the optical element,
the metasurface has positive refractive power, and
in a case where the first optical surface is arranged on the incident side with respect to the second optical surface, the second lens has positive refractive power in a vicinity of the optical axis, and in a case where the second optical surface is arranged on the incident side with respect to the first optical surface, the third lens has positive refractive power,
a solid-state imaging element in which light receiving elements are arranged in a two-dimensional lattice pattern; and
a glass substrate arranged between a light receiving surface of the solid-state imaging element and the lens optical system.
